(19) United States
(12) Patent Application Publication
(10) Pub. No.: US 2004/0091823 A1
(43) Pub. Date: May 13, 2004

(54) Heat development method

(75) Inventor: Tetsuya Kojima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/652,254

(22) Filed: Sep. 2, 2003

(30) Foreign Application Priority Data
Sep. 3, 2002 (JP) P2002-258059

(51) Int. Cl. G03C 5/00

(52) U.S. Cl. 430/350; 430/619

(57) ABSTRACT

In a heat development method for performing heat development by applying light or heat onto a heat-developable recording material including a photothermographic material or a light-sensitive heat-sensitive recording material, it has been configured such that the target temperature of a heater is increased than normal immediately after the start-up of the heat development apparatus, and subsequently, the increase range is reduced with time.

### BACKGROUND OF THE INVENTION

1. Field of the Invention

The present invention relates to the control immediately after the start-up of a heat development apparatus for exposing a heat-developable recording material including a photothermographic material or a light-sensitive heat-sensitive recording material to a laser light or the like.

2. Description of the Related Art

Reduction of waste solutions to be treated has been strongly desired in recent years in the medical field from the viewpoint of environmental protection and space saving. Under such circumstances, technologies on light-sensitive photothermographic materials for medical diagnosis and photography which can be exposed to light efficiently with a laser image setter or a laser imager, and can form a clear black image having high resolution and sharpness have been demanded. These light-sensitive photothermographic materials can offer to customers a simpler and environmentally benign heat development processing system which has eliminated the necessity of using solvent system processing chemicals.

The similar requirements also exist in the field of general image-forming materials. However, the image for medical diagnosis use is required to have a high image quality excellent in sharpness and graininess, because fine details of the image are required. In addition, the medical image is characterized by preferably exhibiting cold black tone from the viewpoint of ease of medical diagnosis. Currently, various hard copy systems utilizing pigments or dyes such as inkjet printers and apparatuses for electrophotography are prevailing as general image-forming systems. However, there is no system satisfactory as a medical image-output system.

In contrast to this, in recent years, a recording apparatus by a dry system not requiring wet processing has attracted attention. In such a recording apparatus, films of light-sensitive and heat-sensitive recording materials (light-sensitive heat-sensitive recording materials) and photothermographic materials are used. Hereinafter, the materials are referred to as “heat-developable recording materials” or “photothermographic materials”. Further, in this recording apparatus by a dry system, a heat-developable recording material is irradiated with a laser light (scanned) at an exposure unit to form a latent image. Thereafter, the heat-developable recording material is brought in contact with a heating means at a heat development unit to perform heat development, followed by slow cooling/cooling. Then, the heat-developable recording material having an image formed thereon is discharged out of the apparatus. Such a dry system is more capable of resolving the problem of the disposal of a waste water than with wet processing.

The foregoing thermal image-forming systems utilizing an organic silver salt are described, for example, in U.S. Pat. Nos. 3,152,904 and 3,457,075, and Thermally Processed Silver Systems, by Shely (Imaging Processes and Materials, Neblette 8th edition, compiled by Sturge, V. Walworth, and A. Shepp, p. 2, 1996). In particular, the heat-developable recording material generally has a light-sensitive layer in which a catalytically active amount of a photocatalyst (e.g., silver halide), a reducing agent, a reducible silver salt (e.g., organic silver salt), and, if required, a toning agent for controlling the tone of silver are dispersed in a binder matrix. The heat-developable recording materials are, after having been imagewise exposed, heated to a high temperature (for example, at 80° C. or higher) to form black silver images through the oxidation-reduction reaction between the silver halide or the reducible silver salt (which functions as an oxidizing agent) and the reducing agent therein. The oxidation-reduction reaction is accelerated by the catalytic action of the latent image of the silver halide generated through exposure. For this reason, the black silver images are formed in the exposed areas. This technique is disclosed in many references including typically U.S. Pat. No. 2,910,377 and JP-B-43-4924. Then, Fuji Medical Dry Imager FM-DP L has been released as a medical image formation system by a heat-developable recording material.

For manufacture of thermal image-forming systems utilizing an organic silver salt, there are a manufacturing method by solvent coating, and a manufacturing method by coating/drying of a coating solution containing polymer fine particles in water dispersion form as a main binder. The latter method does not require the step of solvent recovery, or the like, and hence the manufacturing equipment is simple, and the method is advantageous for mass production.

As the related art in such a heat development apparatus, there is the one disclosed in JP-A-2000-284382 (patent document 1).

This is for keeping the density invariably constant even when ambient temperature changes, and the number of sheets of recorded heat-developable recording material increases. As a solving means therefor, in an image recording apparatus which includes: a recording unit for exposing a heat-developable recording material to light, and forming a latent image; a control unit for controlling the recording unit; a heat development unit for heating the heat-developable recording material by a heating medium, and performing heat development; and a cooling unit for cooling the heat-developable recording material after heat development, the following configuration is adopted. Namely, the apparatus has a temperature sensor for measuring the temperature of the heat-developable recording material before entering into the heat development unit; a temperature sensor for measuring the temperature of the cooling unit inlet; and a light quantity correction circuit for correcting the recording light quantity of the heat-developable recording material based on the output from the temperature sensor, wherein the correction of the light quantity of the light quantity correction circuit is performed in such a manner that the light quantity is reduced with an increase in the temperature of the heat-developable recording material entering into the heat development unit and with an increase in the temperature of the cooling unit inlet after heat development.

However, this is a system whereby the light quantity is changed according to the temperature of the heat-developable recording material entering the heat development unit and the temperature of the cooling unit inlet. Even when the temperature of the mounting site of the thermistor becomes the target temperature, such a difference as seen between the temperatures yet to be stabilized of the rollers around the heat development unit, and the like will not be compensated.

On the other hand, the heat development unit is characterized in that the film recording density becomes likely to decrease regardless of ambient temperature immediately upon start-up of the apparatus. This is the following phenomenon. Even when the temperature of the mounting site of the thermistor becomes the target temperature, the temperatures of the rollers around the heat development unit, and the like are yet to be stabilized, resulting in a reduction of the density. Therefore, the density reduction immediately upon start-up of the heat development apparatus have sometimes presented a problem. As the countermeasure, the extra waiting time after start-up of the apparatus has been allowed for.

Especially, the images by the heat development are widely used in the medical field. In such a case, it has been a large deficiency that the length of time taken until the images of a patient of emergency visit become visible is as long as 20 to 30 minutes or more.

### SUMMARY OF THE INVENTION

The present invention is to solve the foregoing problem. It is an object of the invention to provide a heat development method which does not require an extra waiting time after start-up of a heat development apparatus to be allowed for, therefore can shorten the print time, and can largely shorten the time required for the favorable images of a patient of emergency visit to be observed.

In order to solve the problem, the invention of a heat development method according to claim 1 is a heat development method for performing heat development by applying light or heat onto a heat-developable recording material including a photothermographic material or a light-sensitive heat-sensitive recording material, characterized in that the target temperature of a heater is increased than normal immediately after the start-up of a heat development apparatus, and subsequently, the increase range is reduced with time.

In accordance with this method, it is possible to more stabilize the density, and to shorten the print time.

The invention of a heat development method according to claim 2 is a heat development method for performing heat development by applying light or heat onto a heat-developable recording material including a photothermographic material or a light-sensitive heat-sensitive recording material, characterized in that the recording light quantity or the recording heat quantity is increased than normal immediately after the start-up of a heat development apparatus, and subsequently, the increase range is reduced with time.

In accordance with this method, it is possible to more stabilize the density, and to shorten the print time.

The invention of a heat development method according to claim 3 is a heat development method for performing heat development by applying light or heat onto a heat-developable recording material including a photothermographic material or a light-sensitive heat-sensitive recording material, characterized in that the target temperature of a heater is increased than normal and the recording light quantity or the recording heat quantity is increased than normal immediately after the start-up of a heat development apparatus, and subsequently, the increase range is reduced with time.

In accordance with this method, it is possible to more shorten the print time, and it becomes possible to perform more delicate control.

### BRIEF DESCRIPTION OF THE DRAWINGS

FIG. 1 shows a schematic view of a configuration of a heat development apparatus mounting therein a laser recording device in accordance with the invention.

FIG. 2 shows a block view showing the schematic configurations of a transport part for transporting a sheet-like heat-developable recording material and a scanning exposure part in the laser recording device.

FIG. 3 shows a side view schematically showing the location of a driving roller relative to a guide plate partially on an enlarged scale.

FIG. 4 shows an illustrative view showing the layer configuration of the heat-developable recording material.

FIG. 5 shows an enlarged perspective view illustrating a plate heater with the cover of a heater rack thereof removed.

FIG. 6 shows a perspective view showing the back side of a guide plate made of aluminum.

FIG. 7 shows a graph showing the temperature versus density characteristics of the heat-developable recording material for use in the heat development apparatus.

FIG. 8 shows a diagram showing the plate heater temperature versus time characteristics in accordance with a conventional method and a first embodiment of the inventive method.

FIG. 9 shows a diagram showing the light quantity versus time characteristics in accordance with a conventional method and a second embodiment of the invention.

FIG. 10 shows a diagram illustrating the relationship between the recording density obtained with the inventive method and the recording density obtained with a conventional method with respect to the increase in number of recorded paper sheets from immediately after the start-up of the heat development apparatus.

### DESCRIPTION OF THE PREFERRED EMBODIMENTS

Below, preferred embodiments of a heat development apparatus by laser recording to which the present invention is applied will be described in details by reference to drawings.

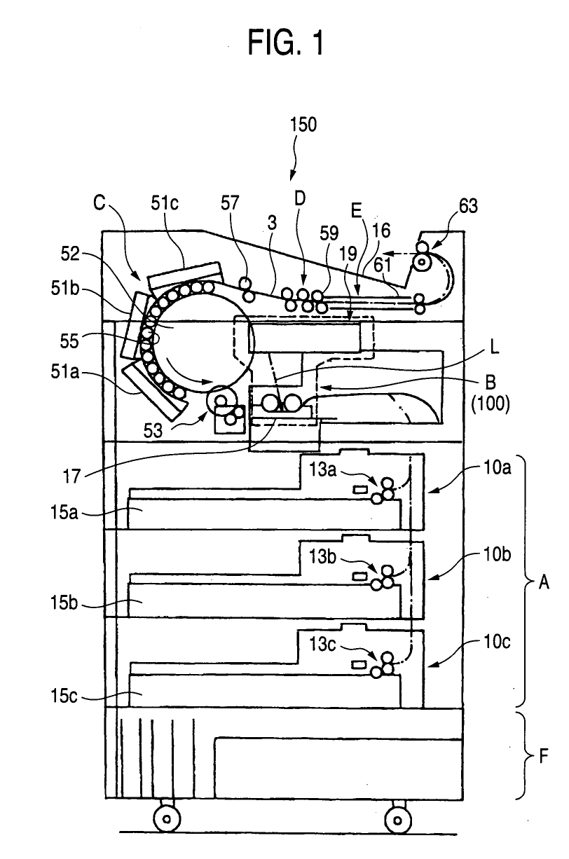

FIG. 1 shows a schematic diagram of a configuration of a heat development recording apparatus 150 mounting a laser recording device 100 therein in accordance with the invention. The heat development recording apparatus 150 is an apparatus which uses a heat-developable recording material not requiring a wet development processing, and exposes the heat-developable recording material with scanning exposure by light beams including a laser light to form a latent image, then, performs heat development to obtain a visible image, and subsequently slowly cools/cools it down to ordinary temperature.

Therefore, the heat development recording apparatus 150 basically includes a heat-developable recording material supply unit A, an image exposure unit (corresponding to the laser recording device 100) B, a heat development unit C, a slowly cooling unit D, and a cooling unit E, sequentially in the direction of transport of the heat-developable recording material. It further includes a transport means disposed at each essential site between respective units, and for transporting the heat-developable recording material, and a power source/control unit F for driving and controlling each unit. At the power source/control unit F, a CPU is disposed, which allows various controls to be performed.

The heat development recording apparatus 150 is configured such that, the power source/control unit F is located at the lowermost stage; the heat-developable recording material supply unit A, on the upper stage; and the image exposure unit B, the heat development unit C, the slowly cooling unit D, and the cooling unit E, at the still upper stage, wherein the image exposure unit B and the heat development unit C are arranged adjacent to each other.

With this configuration, it is possible to perform an exposure step and a heat development step within a short transport distance. This allows the minimization of the transport path length of the heat-developable recording material, which enables the reduction of output time per sheet. Further, it becomes possible to simultaneously carry out both steps of the exposure step and the heat development step on a sheet of heat-developable recording material.

As the heat-developable recording material, a photothermographic material or a light-sensitive heat-sensitive recording material may be used. The photothermographic material is a recording material which is subjected to recording of an image thereon by (exposed to) a light beam (e.g., a laser beam), then heat developed, and allowed to develop its color. Whereas, the light-sensitive heat-sensitive recording material is a recording material which is subjected to recording of an image thereon by a light beam, then, heat developed, and allowed to develop its color, or subjected to recording of an image thereon by a heat mode (heat) of a laser beam, and simultaneously therewith, allowed to develop its color, followed by fixing through light exposure. Incidentally, the details of these recording materials will be described later.

The heat-developable recording material supply unit A is a portion for taking out the heat-developable recording material one sheet by one sheet, and supplying each sheet to the image exposure unit B disposed downstream of the direction of transport of the heat-developable recording material. It comprises three loading members 10a, 10b, and 10c, feeding roller pairs 13a, 13b, and 13c individually located at their respective loading members, and transport rollers and transport guides not shown. Further, inside the respective three-stage structured loading members 10a, 10b, and 10c, magazines 15a, 15b, and 15c, in which different heat-developable recording materials (e.g., B4 size and half-cut size) are accommodated, are inserted, respectively. This allows selective use of any of the materials loaded in the respective stages according to the sizes and orientations thereof.

Incidentally, the heat-developable recording material is processed into sheets, and, in general, made into a prescribed unit of laminate (bundle) of 100 sheets, or the like, and packed in a bag, a belt, or the like, resulting in a package. The packages are respectively accommodated in the magazines, and loaded in the respective stages of the heat-developable recording material supply unit A.

The image exposure unit B causes a light beam L to scan over and expose the heat-developable recording material transported from the heat-developable recording material supply unit A in the main scanning direction, and further transports the material in the sub-scanning direction (i.e., transport direction) roughly orthogonal to the main scanning direction, thereby to record a desirable image on the heat-developable recording material and to form a latent image thereon.

The heat development unit C heat treats the heat-developable recording material after scanning and exposure while transporting it, thereby to perform heat development. Then, in the slowly cooling unit D, the heat-developable recording material after the development processing is slowly cooled, and transported out to a discharge tray 16.

Herein, the image exposure unit B which is the laser recording device 100 will be specifically described.

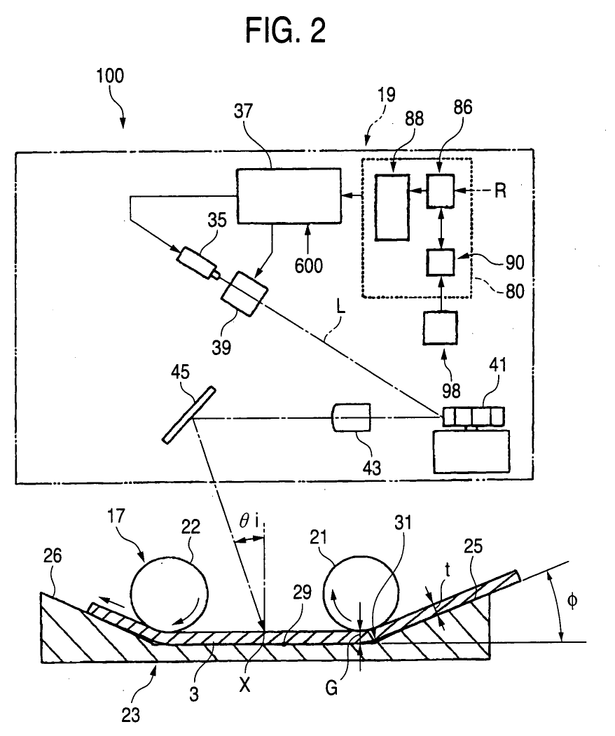

FIG. 2 shows a block diagram showing the schematic configuration of a sub-scanning transport part for transporting a sheet-like heat-developable recording material and a scanning exposure part in the laser recording device 100.

The recording unit B which is the laser recording device 100 is a site for exposing the heat-developable recording material by light beam scanning exposure, and has a sub-scanning transport part (sub-scanning means) 17 having a flapping prevention mechanism for transporting the heat-developable recording material while preventing it from flapping from the transport plane, and a scanning exposure part (laser irradiation means) 19. The scanning exposure part 19 allows the laser to scan (main scan) while controlling the output of the laser in response to the image data separately prepared. At this step, the heat-developable recording material is moved in the sub-scanning direction by the sub-scanning transport part 17.

The sub-scanning transport part 17 includes two driving rollers 21 and 22 disposed across the main scanning line of a laser light to be applied, and having the axis lines generally parallel to the scanning line, and a guide plate 23 disposed in opposition to these driving rollers 21 and 22, and for supporting a heat-developable recording material 3. The guide plate 23 is provided with slope portions 25 and 26 for bending the heat-developable recording material 3 inserted in the gap with the respective driving rollers 21 and 22 along a part of each driving roller circumferential surface outside the region between the parallelly disposed driving rollers, and a pressing portion 29 composed of a roughly horizontal surface which abuts against the heat-developable recording material, and receives the elastic rebound force due to bending thereof between the driving rollers.

The slope portion 25 is an inclined surface connected in a bent manner at the boundary portion to the pressing portion 29, and the crossing angle φ between the slope portion 25 and the pressing portion 29 is set within a range of 0° to 45°. Whereas, the slope portion 26 downstream in the direction of transport is also formed in the same manner, so that it is provided with a surface inclined at the crossing angle of φ to the pressing portion 29. Incidentally, the inclined surface bent at a crossing angle of φ larger than 0° is desirably set at least upstream in the direction of transport.

The driving roller 21 is so configured as to receive the driving force of a driving means such as a motor not shown through a transfer means such as a gear or a belt, and to rotate in a clockwise direction of FIG. 2. Incidentally, the driving roller 22 having the same structure as that of the driving roller 21 is disposed for use in discharging the heat-developable recording material 3 at the boundary position between the slope portion 26 and the pressing portion 29.

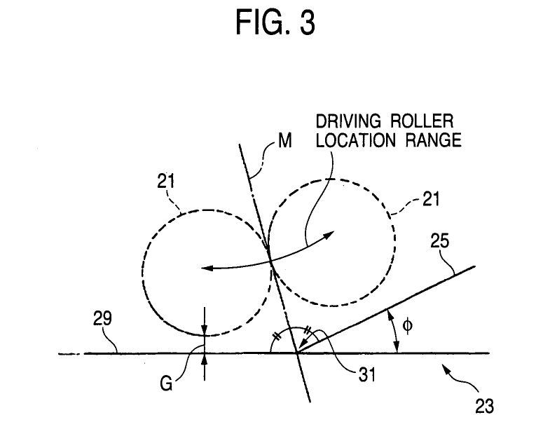

Herein, a description will be given by taking the driving roller 21 as an example. The driving roller 21 is disposed opposite to a bent site 31 which is the boundary portion between the pressing portion 29 and the slope portion 25. The location of the driving roller 21 relative to the guide plate 23 preferably lies, as seen in a side view partially and schematically shown on an enlarged scale in FIG. 3, within a range in which a line M passing through the bent site (angle change point) 31 of the guide plate 23, and halving the interior angle (180°-φ) of the guide plate 23 comes in contact with the outer periphery of the driving roller 21. Incidentally, there is no particular restriction on the relationship between the diameter of the driving roller 21 and the length of the guide plate 23.

Further, the driving roller 21 is disposed so that a prescribed gap G is formed between the circumferential surface thereof and the guide plate 23. The gap G is preferably set at a thickness equal to, to 10 times the wall thickness size t of the heat-developable recording material 3 (t≧G≧lot).

With the configuration of the sub-scanning transport part 17, when the heat-developable recording material 3 penetrates from the tip of the slope portion 25, the tip of the heat-developable recording material 3 enters between the guide plate 23 and the driving roller 21. At this step, the heat-developable recording material 3 sags upon going from the slope portion 25 to the pressing portion 29 because the pressing portion 29 and the slope portion 25 of the guide plate 23 are arranged in a bent manner at a prescribed angle of φ. This sagging generates an elastic rebound force in the heat-developable recording material 3 itself. The elastic rebound force generates a prescribed frictional force between the heat-developable recording material 3 and the driving roller 21. This allows the transport driving force to be transmitted from the driving roller 21 to the heat-developable recording material 3 with reliability. As a result, the heat-developable recording material 3 is transported.

Incidentally, when the heat-developable recording material 3 enters between the guide plate 23 and the driving roller 21, the vibration of the driving roller 21 due to disturbance, or the like will not affect the transport of the heat-developable recording material 3, because the gap G between the driving roller 21 to be driven in a clockwise direction and the guide plate 23 is set at a size equal to the wall thickness size t of the heat-developable recording material 3 to 10 t. Namely, when disturbance occurs, it is absorbed by the elastic force (displacement along the wall thickness direction) of the heat-developable recording material 3. Therefore, the transport will not be affected.

Whereas, with the slope portion 26 and the driving roller 22, the elastic rebound force due to bending of the heat-developable recording material 3 causes a prescribed frictional force with the driving roller 22 also when the heat-developable recording material 3 is discharged from the guide plate 23. This ensures the transportation with reliability.

Whereas, at the pressing portion 29, the heat-developable recording material 3 is pressed against the pressing portion 29 due to the elastic rebound force of the heat-developable recording material 3. This inhibits the flapping from the transport plane of the heat-developable recording material 3, i.e., the vertical flapping thereof. By applying a laser light onto the heat-developable recording material 3 between the driving rollers, it becomes possible to perform favorable recording without exposure misalignment.

On the other hand, the scanning exposure part 19 is, as shown in FIG. 2, for deflecting the laser light L modulated in response to an image signal in the main-scanning direction, and making it incident upon a prescribed recording position X. It has a laser light source 35 for emitting a laser light in a narrow-band wavelength range (wavelength 350 nm to 900 nm) corresponding to the spectral sensitivity characteristic of the heat-developable recording material 3, a recording control unit 37 for driving the laser light source 35, a cylindrical lens 39, a polygon mirror 41 which is an optical polarizer, a fθ lens 43, and a turning-down cylindrical mirror 45.

Incidentally, in the scanning exposure part 19, other than these, there are disposed, if required, various optical system components to be disposed in known light beam scanning exposure units, such as a collimator lens for shaping a light beam emitted from the laser light source 35, a beam expander, a deformed-plane correction optical system, and an optical path adjusting mirror. Incidentally, the recording beam diameter on the heat-developable recording material 3 of the laser light is set at θ50 to θ200 μm. Particularly, the recording beam diameter in the sub-scanning direction is preferably smaller for reducing the interference area.

Herein, the exposure mode is such that image recording is performed with pulse width modulation. The recording control unit 37 pulse-width modulates and drives the laser light source 35 according to an image to be recorded, and causes it to emit a light beam pulse-width modulated according to the image to be recorded. The laser light L emitted from the laser light source 35 is deflected in the main scanning direction by the polygon mirror 41, and dimmed by the fθ lens 43 so as to form an image at a recording position X. The optical path thereof is then selected by the cylindrical mirror 45, so that the laser light L is made incident upon the recording position X at a prescribed angle of incidence θi. Namely, the laser light L is applied onto the heat-developable recording material 3 at an angle of incidence θi tilted at 4° to 150 from the normal to the heat-developable recording material 3 toward the sub-scanning direction within a plane parallel to the normal direction to the heat-developable recording material 3 and the sub-scanning direction (transport direction).

Then, the heat development unit C will be described.

The heat development unit C heats the heat-developable recording material to be heat treated, of the type to which a heat treatment is applicable. As shown in FIG. 1, it is configured such that a plurality of plate heaters 51a, 51b, and 51c as heating members, which will increase in temperature to the temperature necessary for processing the heat-developable recording material 3, arranged along the direction of transport of the heat-developable recording material 3, are shaped each in a bent form, and that these plate heaters 51a, 51b, and 51c are disposed in a sequential circular-arc.

Namely, the heat development unit C including the plate heaters 51a, 51b, and 51c are configured as follows. As shown, each plate heater has a concave surface. The heat-developable recording material 3 is slid along the concave surface of the plate heater while being in contact therewith, and relatively moved. As transportation means of the heat-developable recording material 3 for this step, there are disposed a supply roller 53, and a plurality of pressing rollers 55 which are also for heat transfer from the respective plate heaters to the heat-developable recording material 3. The pressing rollers 55 abut against the circumferential surface of a drum 52, so that it is driven in rotation, following the rotation of the drum 52. As these pressing rollers 55, metal rollers, resin rollers, rubber rollers, and the like are available. With this configuration, the heat-developable recording material 3 to be transported is transported while being pressed against the plate heaters 51a, 51b, and 51c. Therefore, it is possible to prevent the buckling of the heat-developable recording material 3. Whereas, a discharge roller 57 for transporting the heat-developable recording material 3 is disposed at the terminal of the transportation path for the heat-developable recording material 3 in the heat development unit C.

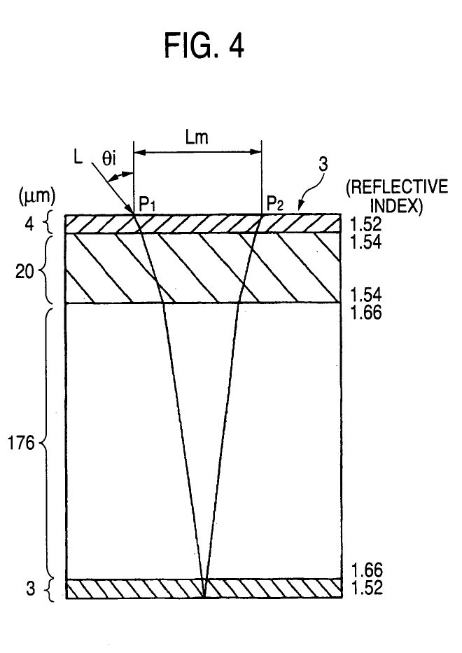

FIG. 4 is an illustrative diagram showing the layer configuration of the heat-developable recording material.

First, the configuration of the heat-developable recording material 3 will be described. As shown in FIG. 4, the heat-developable recording material is configured as follows. On a 176 μm-thick base film made of PET (polyethylene terephthalate) material, and the like, a 20 μm-thick emulsion layer Em is coated, and a 4 μm-thick protective layer PC is coated on the surface of the emulsion layer Em. Further, on the back of the base film, a back coat layer BC and an antihalation layer AH are coated with a total thickness of 3 μm. The total thickness of the heat-developable recording material 3 is set within a range of 150 to 250 μm.

The refractive indexes are: 1.52 for the protective layer PC, 1.54 for the emulsion layer Em, 1.66 for the base film (PET), and 1.52 for the backcoat layer BC and the antihalation layer AH. These average about 1.5 to 1.7. Incidentally, the usable heat-developable recording material 3 has, when unrecorded, an optical transmittance at the wavelength of the exposure laser light of 50% or less, and preferably 30% or less.

When a laser light is made incident upon the heat-developable recording material 3 from the protective layer PC side, the laser light advances therethrough while refracting the optical path at the interfaces. The laser light is then reflected from the interface with air on the side of the undermost backcoat layer BC and antihalation layer AH, and the reflected light is returned to the protective layer PC again. When the distance Lm between the laser light incidence position P1 and the reflected light emission position P2 on the heat-developable recording material surface is larger than the beam diameter of the laser light at this step, the problem of interference is avoided.

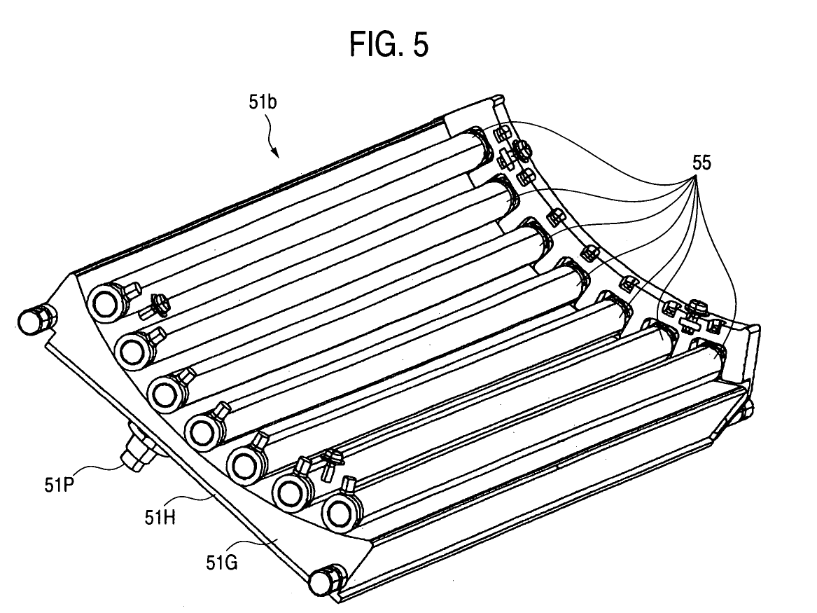

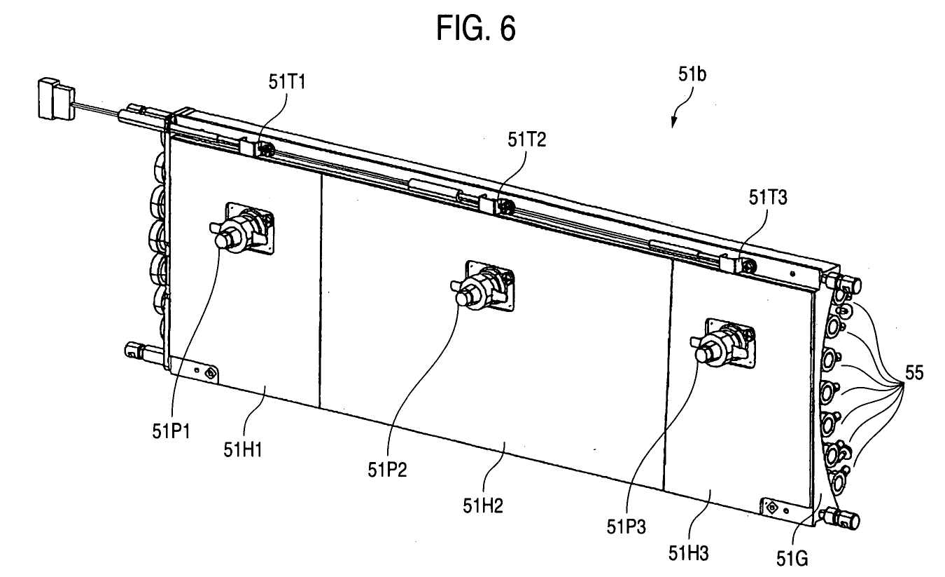

FIG. 5 is an enlarged perspective view of one of the plate heaters 51a, 51b, and 51c, for example, 51b, which is shown with the cover of a heater rack removed. The plate heater 51b includes a guide plate 51G made of aluminum, a silicon rubber heater 51H, a thermistor 51T (FIG. 6), a heater terminal (protector) 51P, and pressing rollers 55.

The guide plate 51G made of aluminum is formed concavely along the direction of advance of the heat-developable recording material. The seven pressing rollers 55 are laid, each extending along the width of the guide plate 51G made of aluminum, and at an equal pitch along the direction of advance. They perform the function of transporting the heat-developable recording material fed onto the concave surface while pressing it against the concave surface.

The three silicon rubber heaters 51H are laid on the back side (on the side opposite from the concave surface) of, and along the width of the guide plate 51G made of aluminum. FIG. 6 is a perspective view showing the back side of the guide plate 51G made of aluminum. In FIG. 6, the three silicon rubber heaters 51H1 to 51H3 are laid on the back side of, and along the width of the guide plate 51G made of aluminum. The three thermistors (temperature sensors) 51T to 51T3 are mounted on the edges of their respective silicon rubber heaters 51H1 to 51H3. Namely, a total of nine silicon rubber heaters 51H are used three for each of the plate heaters 51a, 51b, and 51c, and the thermistors 51T are disposed one on each of the silicon rubber heaters 51H. Thus, the respective nine silicon rubber heaters 51H are independently controlled by their corresponding thermistors 51T.

Thus, the thermistors 51T cannot be disposed on the guide plate 51G made of aluminum over which the heat-developable recording material passes. In actuality, they are thus disposed on the back side of, and on the edge of the guide plate 51G made of aluminum. This causes a difference between the measured value by each thermistor and the temperature of the guide plate made of aluminum at the heat-developable recording material passing portion immediately after the start-up of the apparatus until the temperature reaches a stationary state.

Incidentally, the foregoing bent plate heater is one example. Other flat plate heaters or heating drums may also be used to implement a configuration including an endless belt and a stripping nail.

Then, the heat-developable recording material 3 transported out from the heat development unit C is slowly cooled by the slowly cooling unit D with attention paid to prevent the generation of wrinkles, and the formation of the bending habit.

In the slowly cooling unit D, a plurality of slowly cooling roller pairs 59 are disposed so as to impart a given desirable curvature R to the transportation path for the heat-developable recording material 3. This allows the heat-developable recording material 3 to be transported with the given curvature R until it is cooled to the glass transition temperature of the material thereof or lower. By intentionally imparting the curvature to the heat-developable recording material 3 in this manner, the heat-developable recording material 3 will not have a needless curl before it is cooled to the glass transition temperature or lower. When it is cooled to the glass transition temperature or lower, it will not have another curl, so that the amount of formed curls does not vary.

Further, the slowly cooling rollers themselves and the inner atmosphere of the slowly cooling unit D are temperature controlled. Such temperature control can equalize, as much as possible, the conditions immediately after the start-up of the heat treatment apparatus and after sufficient running thereof, and reduce the density fluctuations.

The heat-developable recording material 3 cooled down to the glass transition point or lower in the slowing cooling unit D is transported out to the cooling unit E by the transportation roller pair 59 disposed in the vicinity of the outlet of the slowly cooling unit D.

The cooling unit E includes cooling plates 61, where the heat-developable recording material 3 is further cooled down to such a temperature as to cause no burn injury even when taken by hand. Thereafter, it is discharged to the discharge tray 16 by a discharge roller pair 63.

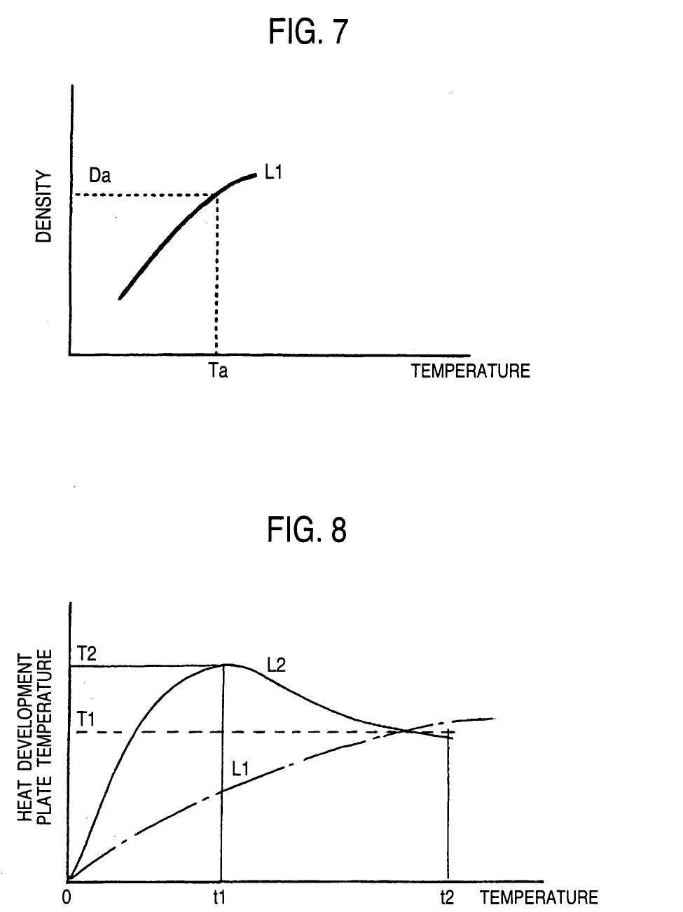

FIG. 7 shows the temperature versus density characteristics of the heat-developable recording material for use in this apparatus. In FIG. 7, the abscissa denotes the temperature, and the ordinate denotes the density. The temperature versus density characteristics of the heat-developable recording material for use in such a case shows the tendency as indicated by a line L1. Namely, the heat-developable recording material has the following characteristics: when it has a density Da at a temperature Ta, as the temperature increases than that, the density also increases, and as the temperature decreases, the density also rapidly decreases. The composition of the heat-developable recording material showing such a tendency will be described in details later. Thus, even when the temperature of the plate heaters is a little low, the density remarkably decreases. This necessitates the control of the temperature of the plate heaters with precision in order to obtain a prescribed density.

However, as described previously, the temperature sensors cannot be disposed on the plate heaters over which the heat-developable recording material pass, and in actuality, disposed on the back side of each plate heater. This causes a difference between the measured value by the temperature sensors and the temperature of the plate heater at the heat-developable recording material passing portion immediately after the start-up of the apparatus until the temperature reaches a stationary state. Therefore, the following case has often occurred: even when the measured temperature of the temperature sensor has reached a target value, the density is insufficient upon recording. As the countermeasure, such a problem has been conventionally coped with by taking an extra time allowing for the time lag period after the start-up of the apparatus.

FIG. 8 is a chart showing the plate heater temperature versus time characteristics in accordance with a conventional method and a first embodiment of the inventive method.

In the chart, the abscissa denotes the time, and the ordinate denotes the plate heater temperature (the detected temperature of the temperature sensor). L1 shows the characteristic line of the plate heater temperature versus time of the conventional method. L2 shows that of the inventive method.

In accordance with the conventional method, the plate heater temperature after the start-up of the heat development apparatus slowly rises as indicated by L1. The apparatus becomes usable finally at the time point t2 when the plate heater temperature T1 has reached the recordable temperature of T1 (strictly, at a slightly delayed timing than that in consideration of the time lag period between the detected temperature and the real temperature of the temperature sensor).

In contrast to this, in accordance with the first embodiment of the invention, it is configured such that the plate heater temperature after the start-up of the heat development apparatus will rapidly exceeds the recordable temperature T1 by setting the target temperature T2 higher than the normal temperature T1 by about 5 to 20° C. as indicated by L2. This allows the apparatus to have already been usable at the time point of t1 in consideration of the time lag period.

Therefore, the usable time is t1 in accordance with the invention, while the usable time is t2 in accordance with the conventional method. The difference therebetween t2-t1 corresponds to the length of time shorten by the invention. In general, this value corresponds to 1 to 20 minutes. For the heat developed images for use in the medical field, this time reduction is precious for a patient of emergency visit and the doctor in charge.

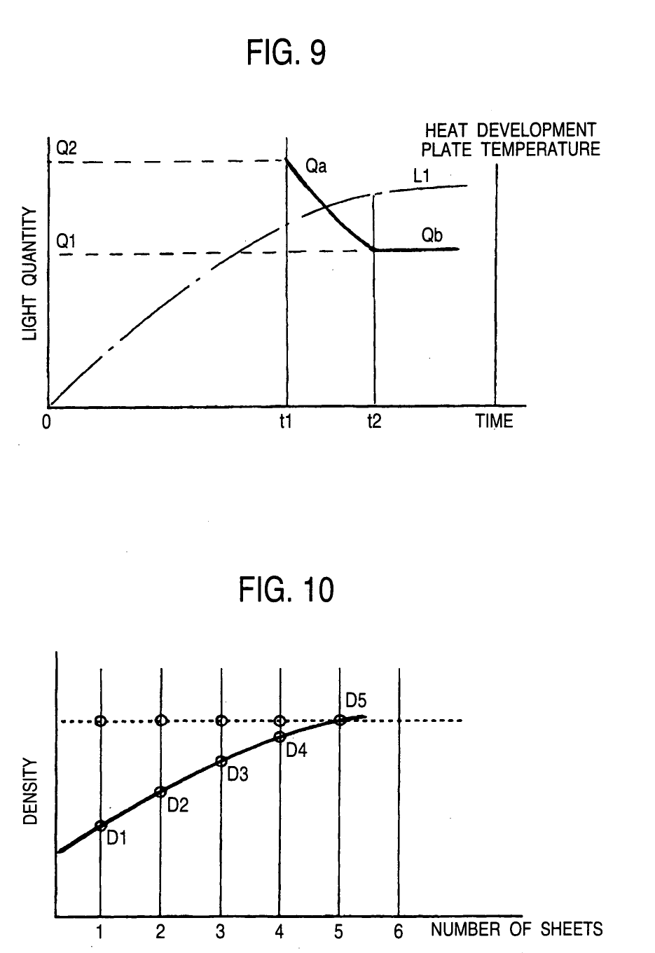

FIG. 9 is a chart showing the light quantity versus time characteristics in accordance with a conventional method and a second embodiment of the invention.

In the chart, the abscissa denotes the time, and the ordinate denotes the light quantity. Qb denotes the characteristic line of the light quantity versus time in accordance with the conventional method; Qa, the characteristic line of the light quantity versus time in accordance with the second embodiment of the invention; Q1, a first light quantity; Q2, a second light quantity; and Q1<Q2. Whereas, L1 is a general characteristic line of the plate heater temperature versus time.

The manner in which the light quantity is provided in accordance with the conventional method is as follows. As indicated by Qb, the apparatus becomes usable at the time point t2 when the plate heater temperature versus time characteristic line L1 described in connection with FIG. 8 has reached the recordable temperature. The apparatus starts recording from this time point with the general light quantity Q1 (constant).

In contrast to this, the manner in which the light quantity is provided in accordance with the second embodiment is as follows. As indicated by Qa, the apparatus starts recording at the time point t1 before the plate heater temperature reaches the recordable temperature. However, the light quantity provided at this step is not the general Q1, but Q2 which is higher than Q1, as represented by the formula (1):

Q2=(1.3 to 1.6)×Q1 (1)

Then, the range of light quantity to be increased is reduced with an increase in plate heater temperature, so that the light quantity finally returns to the general light quantity Q1 (constant) at the time point t2.

Therefore, the usable time is t1 in accordance with the second embodiment, while the usable time is t2 in accordance with the conventional method. The difference therebetween t2-t1 corresponds to the length of time shorten by the second embodiment. In general, this value corresponds to 1 to 20 minutes.

FIG. 10 illustrates the relationship between the recording density obtained by the inventive method and the recording density obtained by the conventional method with respect to the increase in number of recorded sheets from immediately after the start-up of the heat development apparatus when the general characteristic line of the plate heater temperature and time shows the tendencies indicated by L1 of FIGS. 8 and 9. This indicates as follows. In accordance with the conventional method, the density also increases with an increase in number of sheets from 1 to 4. However, it is a prescribed density or lower, and the density of the fifth sheet finally reaches the prescribed density.

In contrast to this, in accordance with the first and second embodiments of the invention, the prescribed density is abruptly reached from the first sheet, and subsequently the density is kept.

Therefore, in accordance with the invention, it is possible to perform recording from the first heat-developable recording material sheet without waste.

Incidentally, experiments were performed using DI-AL Em. No. 51151 (expiration date December, 2003) manufactured by Fuji Photo Film Co., Ltd., as a heat-developable recording material, and it has been shown that the same properties/effects as described above can be obtained.

Then, a third embodiment of the invention is a combination of the first and second embodiments. Namely, in a heat development method for performing heat development by applying light or heat onto a heat-developable recording material including a photothermographic material or a light-sensitive heat-sensitive recording material, it is configured such that the target temperature of the plate heater is increased than normal, and the recording light quantity or the recording heat quantity is also increased than normal immediately after the start-up of the heat development apparatus, and subsequently, the increase range is to be reduced with time.

By adopting such a method, the effects of the first embodiment and the effects of the second embodiment occur as synergistic effects. This allows further shortening of the print time, and more delicate control.

Below, the heat-developable recording material for use in the invention will be described.

(Explanation of Organic Silver Salt)

The organic silver salt usable in this embodiment is a silver salt, which is relatively stable to light, but functions as a silver ion source, and forms a silver image when heated to 80° or higher in the presence of a light-sensitive silver halide exposed to light and a reducing agent. The organic silver salt may be a given organic substance capable of supplying silver ions reducible by a reducing agent. Such non-light-sensitive organic silver salts are described in paragraph Nos. 0048 to 0049 of JP-A-10-62899, on page 18, line 24 to page 19, line 37 of EP 0803764A1, EP 0962812A1, JP-A-11-349591, JP-A-2000-7683, JP-A-2000-72711, and the like. A silver salt of an organic acid, particularly, the silver salt of a long chain aliphatic carboxylic acid (having 10 to 30, preferably 15 to 28 carbon atoms) is preferred. Preferred examples of the fatty acid silver salt include silver lignocerate, silver behenate, silver arachidinate, silver stearate, silver oleate, silver laurate, silver caproate, silver myristate, silver palmitate, and silver erucate, and mixtures thereof. In this embodiment, out of these fatty acid silvers, it is preferable to use fatty acid silvers having a silver behenate content of preferably 50 mol % or more, more preferably 85 mol % or more, and furthermore preferably 95 mol % or more.

The organic silver salt usable in this embodiment has no particular restriction on its shape, and it may have any of needle-shaped, rod-shaped, tabular and scaly forms.

In this embodiment, a scaly organic silver salt is preferred. Whereas, hour hand-shaped, rectangular prismatic, cubic, or potato-shaped indefinite-form particles each having a ratio of length between the major axis and the minor axis of 5 or less are also preferably used. These organic silver particles have a feature of causing less fog upon heat development than with the minute hand-shaped particles having a ratio of length between the major axis and the minor axis of 5 or more. In particular, the particles with a ratio between the major axis and the minor axis of 3 or less improves the mechanical stability of the resulting coating film, and hence they are preferred. In this specification, the scaly organic silver salt is defined as follows. The organic acid silver salt is observed by means of an electronic microscope, and the shape of the organic acid silver salt particle is approximated to a rectangular parallelepiped. When the sides of the rectangular parallelepiped are taken as a, b, and c in the order from the shortest (c may be equal to b), x is calculated from the shorter numerical values, a and b, and determined as follows.

x=b/a

Thus, x is determined for each of about 200 particles in this manner, and when the average value is taken as x (average), those satisfying the relationship: x (average)≧1.5, are regarded as scaly particles. Preferably, 30≧x (average)≧1.5, and more preferably, 20x (average)≧2.0. In this connection, needle-shaped particles satisfy the relation: 1≦x (average)<1.5.

In a scaly particle, a can be regarded as the thickness of a tabular particle having a plane with sides of b and c as the main plane. The average of a is preferably 0.01 μm or more to 0.23 μm, and more preferably 0.1 μm or more to 0.2 μm or less. The average of c/b is preferably 1 or more to 6 or less, more preferably 1.05 or more to 4 or less, furthermore preferably 1.1 or more to 3 or less, and in particular, preferably 1.1 or more to 2 or less.

It is preferable that the particle size distribution of the organic silver salt is monodispersed. Being “monodispersed” corresponds to the case where the percentage of a value, obtained by dividing the standard deviations of their respective lengths of a minor axis and a major axis by the lengths of the minor axis and the major axis, respectively, is preferably 100% or less, more preferably 80% or less, and furthermore preferably 50% or less. The shape of an organic silver salt can be determined from a transmission electron microscope image of the organic silver salt dispersion. As another method for determining the monodispesibility, there is a method of determining the standard deviation of the volume weight average diameter of an organic silver salt. The percentage of the value obtained by dividing the standard deviation by the volume weight average diameter (coefficient of variation) is preferably 100% or less, more preferably 80% or less, and furthermore preferably 50% or less. For example, the monodispersibility can be determined from the particle size (volume weight average diameter) obtianed by irradiating an organic silver salt dispersed in a solution with a laser light, and determining the autocorrelation function of fluctuation of scattered light on the basis of the change in time.

To the manufacturing and dispersion methods of the organic acid silver salts for use in this embodiment, known methods and the like can be applied. For example, the following references can serve as a reference: JP-A-10-62899, EP 0803763A1, EP 0962812A1, JP-A-11-349591, JP-A-2000-7683, JP-A-2000-72711, Japanese Patent Application Nos. 11-348228 to 30, 11-203413, 2000-90093, 2000-195621, 2000-191226, 2000-213813, 2000-214155, and 2000-191226.

Incidentally, when a light-sensitive silver salt coexists during dispersing the organic silver salt, fog increases, and the sensitivity is remarkably lowered. For this reason, it is more preferable that a light-sensitive silver salt is substantially not included during dispersing. In this embodiment, the amount of a light-sensitive silver salt to be dispersed in an aqueous dispersion is preferably 1 mol % or less, and more preferably 0.1 mol % or less per mole of the organic acid silver salt in the dispersion. Furthermore preferably, the light-sensitive silver salt is not positively added.

In this embodiment, it is possible to manufacture the light-sensitive material by mixing an aqueous dispersion of the organic silver salt and an aqueous dispersion of the light-sensitive silver salt. The mixing ratio of the light-sensitive silver salt to the organic silver salt can be selected according to the intended purpose. The ratio of the light-sensitive silver salt to the organic silver salt is preferably in the range of 1 to 30 mol %, more preferably 2 to 20 mol %, and in particular preferably 3 to 15 mol %. For mixing, it is a method preferably used for adjusting the photographic characteristics that two or more kinds of aqueous dispersions of organic silver salts and two or more kinds of aqueous dispersions of light-sensitive silver salts are mixed.

The organic silver salt of this embodiment can be used in a desirable amount. It is used in an amount of, preferably 0.1 to 5.0 g/m², more preferably 0.3 to 3.0 g/m², and furthermore preferably 0.5 to 2.0 g/m², in terms of the total coating amount of silver also containing silver halide. In particular, the total coating amount of silver is preferably 1.8 g/m² or less, and more preferably 1.6 g/m² or less in order to improve the image storage stability. When the preferred reducing agents of this embodiment are used, it is possible to obtain a sufficient image density even with such a low silver amount.

(Explanation of Reducing Agent)

The photothermographic material of this embodiment preferably contains a heat developer which is a reducing agent for organic silver salts. The reducing agent for organic silver salts may be a given substance (preferably an organic substance) capable of reducing silver ions into metallic silver. Examples of such a reducing agent are described in paragraph Nos. 0043 to 0045 of JP-A-11-65021, and from page 7, line 34 to page 18, line 12 of EP 0803764A1

In this embodiment, preferred reducing agents are so-called hindered phenol type reducing agents having substituents at the ortho positions of the phenolic hydroxyl group, or bisphenol type reducing agents. The compounds represented by the following formula (R) are more preferred.

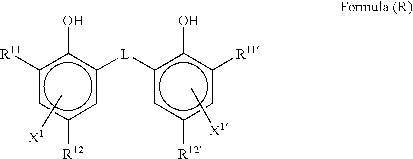

(where in the formula (R), R11 and R11′ each independently represents an alkyl group having 1 to 20 carbon atoms; R12 and R12′ each independently represents a hydrogen atom or a substituent substitutable on a benzene ring; L represents a —S— group or a —CHR13-group; R13 represents a hydrogen atom or an alkyl group having 1 to 20 carbon atoms; and X1 and X1′ each independently represents a hydrogen atom or a group substitutable on a benzene ring).

The formula (R) will be described in details.

R11 and R11′ each independently represents a substituted or unsubstituted alkyl group having 1 to 20 carbon atoms. The substituent of the alkyl group has no particular restriction. Preferably, mention may be made of an aryl group, a hydroxy group, an alkoxy group, an aryloxy group, an alkyl thio group, an aryl thio group, an acylamino group, a sulfonamide group, a sulfonyl group, a phosphoryl group, an acyl group, a carbamoyl group, an ester group, an ureido group, an urethane group, a halogen atom, and the like.

R12 and R12′ each independently represents a hydrogen atom, or a substituent substitutable on a benzene ring, and X1 and X1′ also each independently represents a hydrogen atom, or a substituent substitutable on a benzene ring. As the respective groups substitutable on a benzene ring, preferably, mention may be made of an alkyl group, an aryl group, a halogen atom, an alkoxy group, and an acylamino group.

L represents a —S— group or a —CHR13— group. R13 represents a hydrogen atom or an alkyl group having 1 to 20 carbon atoms. The alkyl group may have a substituent. Specific examples of an unsubstituted alkyl group of R13 may include: a methyl group, an ethyl group, a propyl group, a butyl group, a heptyl group, an undecyl group, an isopropyl group, a 1-ethylpentyl group, and a 2,4,4-trimethylpentyl group. Examples of the substituent of an alkyl group may include the same groups as for the substituent of R11.

R11 and R11′ are preferably secondary or tertiary alkyl groups each having 3 to 15 carbon atoms. Specifically, mention may be made of an isopropyl group, an isobutyl group, a t-butyl group, a t-amyl group, a t-octyl group, a cyclohexyl group, a cyclopentyl group, a 1-methycyclohexyl group, a 1-methylcyclopropyl group, and the like. R11 and R11′ are more preferably tertiary alkyl groups each having 4 to 12 carbon atoms. Out of these, a t-butyl group, a t-amyl group, and a 1-methylcyclohexyl group are further preferred, and a t-butyl group is most preferred.

R12 and R12′ are preferably alkyl groups each having 1 to 20 carbon atoms. Specific examples thereof may include: a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, and a methoxyethyl group. More preferred are a methyl group, an ethyl group, a propyl group, an isopropyl group, and a t-butyl group.

X1 and X1′ are preferably hydrogen atoms, halogen atoms, or alkyl groups, and more preferably hydrogen atoms.

L is preferably a —CHR13— group.

R13 is preferably a hydrogen atom or an alkyl group having 1 to 15 carbon atoms. The alkyl groups are preferably a methyl group, an ethyl group, a propyl group, an isopropyl group, and a 2,4,4-trimethylpentyl group. R13 is in particular preferably a hydrogen atom, a methyl group, an ethyl group, a propyl group, or an isopropyl group.

When R13 is a hydrogen atom, R12 and R12′ are preferably alkyl groups each having 2 to 5 carbon atoms. An ethyl group and a propyl group are more preferred, and an ethyl group is most preferred.

When R13 is a primary or secondary alkyl group having 1 to 8 carbon atoms, R12 and R12′ are preferably methyl groups. The primary or secondary alkyl group having 1 to 8 carbon atoms of R13 are more preferably a methyl group, an ethyl group, a propyl group, or an isopropyl group, and further preferably a methyl group, an ethyl group, or a propyl group.

When all of R11, R11′, R12, and R12′ are methyl groups, R13 is preferably a secondary alkyl group. In this case, the secondary alkyl group of R13 is preferably an isopropyl group, an isobutyl group, and a 1-ethylpentyl group, and more preferably an isopropyl group.

The reducing agent varies in heat developability and developed silver tone according to the combination of R11, R11, R12, R12′, and R13. It is possible to adjust these properties by combining two or more reducing agents. Therefore, the reducing agents are preferably used in combination of two or more kinds thereof according to the intended purpose.

Below, specific examples of the reducing agent of this embodiment including the compounds represented by the formula (R) will be shown, but this embodiment is not limited thereto.

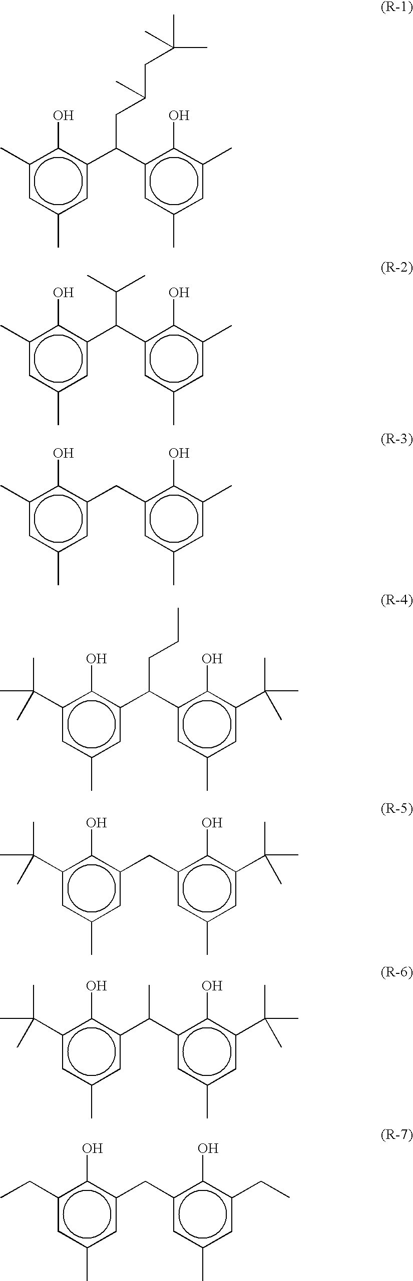

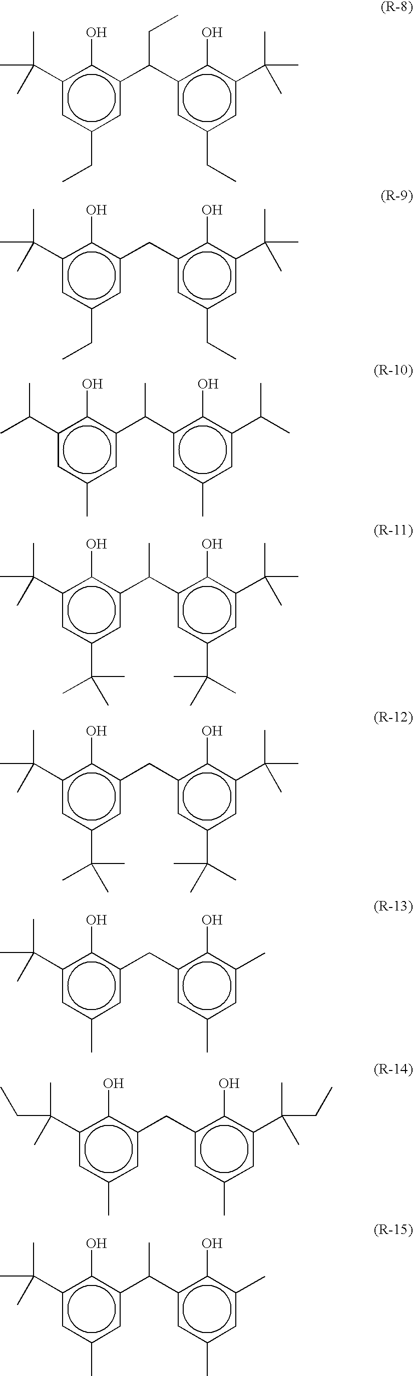

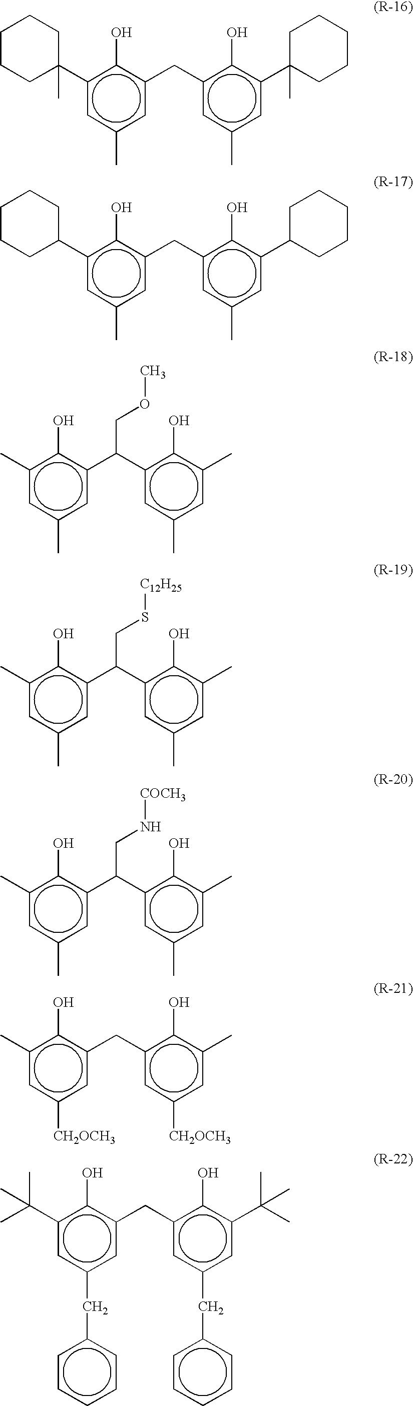

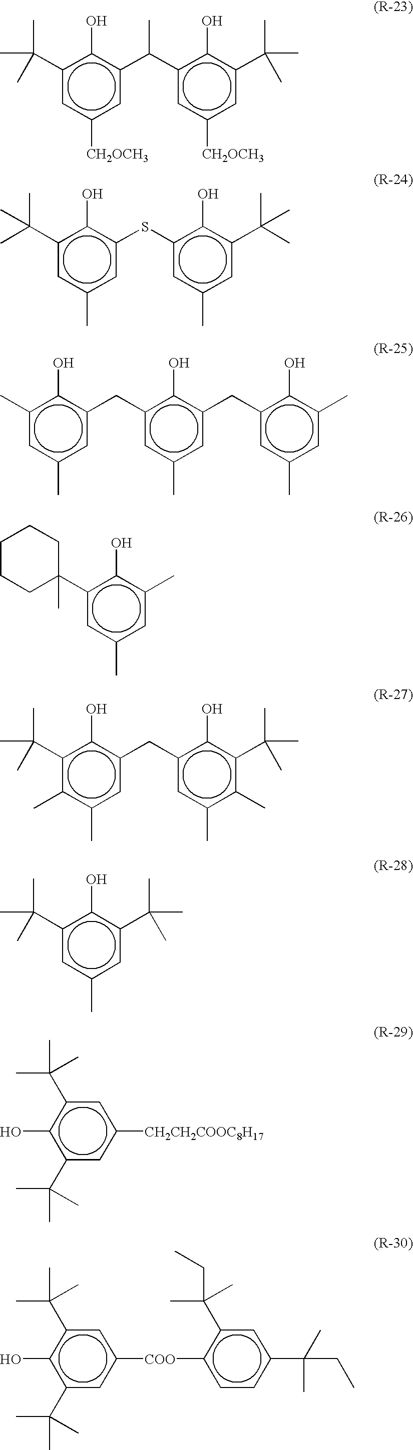

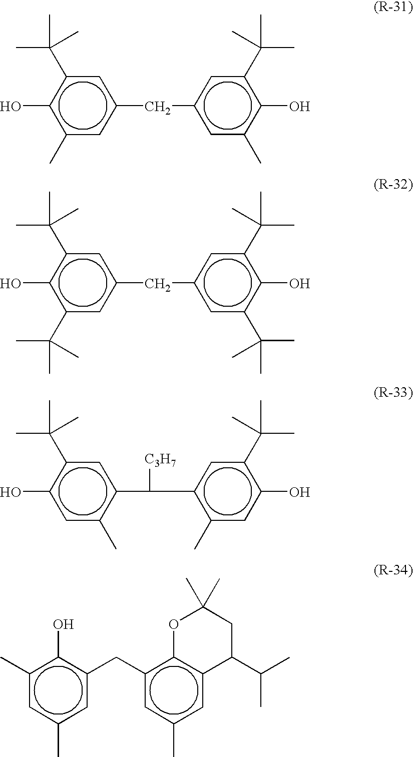

In this embodiment, the amount of the reducing agent to be added is preferably 0.1 to 3.0 g/m², more preferably 0.2 to 1.5 g/m², and further preferably 0.3 to 1.0 g/m². The reducing agent is contained in an amount of preferably 5 to 50 mol %, more preferably 8 to 30 mol %, and further preferably 10 to 20 mol % per mole of silver in the side having an image forming layer. The reducing agent is preferably contained in the image forming layer.

The reducing agent may be incorporated in the coating solution with any process based on a solution form, an emulsified dispersion form, a solid fine particle dispersion form or the like, and incorporated in the light-sensitive material.

As a well-known emulsification dispersion method, mention may be made of a method in which an emulsified dispersion is mechanically prepared by dissolving the reducing agent with an oil such as dibutylphthalate, tricresyl phosphate, glyceryl triacetate or diethyl phthalate and with a co-solvent such as ethyl acetate or cyclohexanone.

Whereas, as a solid fine particle dispersion process, mention may be made of the following method. A powder of a reducing agent is dispersed in an appropriate solvent such as water by means of a ball mill, a colloid mill, a vibration ball mill, a sand mill, a jet mill, or a roller mill, or ultrasonically, thereby to form a solid dispersion. Incidentally, at this step, a protective colloid (e.g., polyvinyl alcohol), a surfactant (e.g., an anionic surfactant such as sodium triisopropylnaphthalene sulfonate (a mixture of those mutually different in substitution positions of three isopropyl groups) may also be used. In the foregoing mills, beads of zirconia or the like are normally used, so that Zr and the like eluted from these beads may be mixed in the resulting dispersion. Although depending upon the dispersion conditions, the concentration is generally in the range of 1 ppm to 1000 ppm. A content of Zr in the sensitive material of 0.5 mg or less per gram of silver is practically acceptable.

An antiseptic agent (e.g., benzoisothiazolinone sodium salt) is preferably incorporated in a water dispersion.

In this embodiment, the reducing agent is preferably used in the form of a solid dispersion.

(Explanation of Development Accelerator)

For the photothermographic material of this embodiment, there are preferably used, as development accelerators, the sulfonamidephenol type compounds represented by the formula (A) described in JP-A-2000-267222, JP-A-2000-330234, and the like, the hindered phenol type compounds represented by the formula (II) described in JP-A-2001-92075, the hydrazine type compounds represented by the formula (I) described in JP-A-10-62895, JP-A-11-15116, and the like, and the formula (1) described in Japanese Patent Application No. 2001-074278, and the phenol type or naphtol type compounds represented by the formula (2) described in Japanese Patent Application No. 2000-76240. Each of these development accelerators is used in an amount in the range of 0.1 to 20 mol %, preferably in the range of 0.5 to 10 mol %, and more preferably in the range of 1 to 5 mol % based on the amount of the reducing agent. As a process for introducing it into a sensitive material, mention may be made of the same process for the reducing agent. In particular, the development accelerator is preferably added in the form of a solid dispersion or an emulsified dispersion. When it is added in the form of an emulsified dispersion, it is preferably added in the form of an emulsified dispersion obtained by dispersing the compound using a high boiling solvent which is a solid at ordinary temperatures, and a low boiling co-solvent, or added in the form of a so-called oil-less emulsified dispersion not using a high boiling solvent.

Out of the development accelerators, particularly preferred are the hydrazine type compounds represented by the formula (1) described in Japanese Patent Application No. 2001-074278, and the phenol type or naphthol compounds represented by the formula (2) described in Japanese Patent Application No. 2000-76240.

Below, preferred specific examples of the development accelerator will be shown. This embodiment is not limited to these.

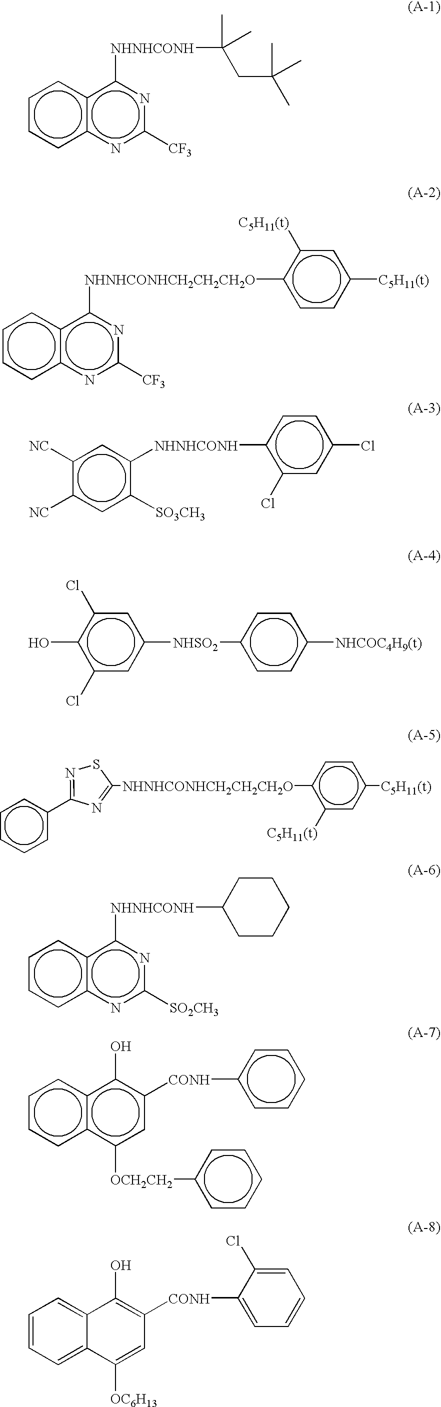

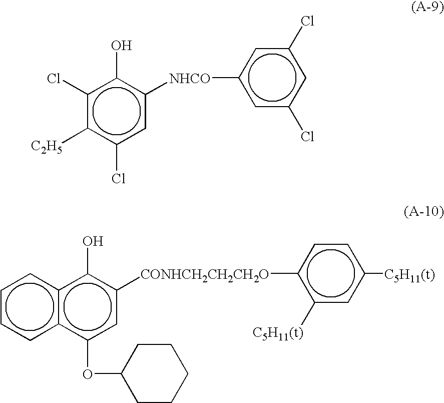

(Explanation of Hydrogen Bonding Compound)

When the reducing agent has an aromatic hydroxy group (—OH), particularly in the case of the foregoing bisphenols, a non-reducible compound having a group capable of forming a hydrogen bond with each of these groups is preferably used in combination. As the groups forming a hydrogen bond with a hydroxy group or an amino group, mention may be made of a phosphoryl group, a sulfoxide group, a sulfonyl group, a carbonyl group, an amide group, an ester group, an urethane group, an ureido group, a tertiary amino group, a nitrogen-containing aromatic group, and the like. Out of these, preferred are a phosphoryl group, a sulfoxide group, an amide group (provided that it does not have an>N—H group, but is blocked like an >N—Ra (Ra is a substituent other than H)), an urethane group (provided that it does not have an>N—H group, but is blocked like an>N—Ra (Ra is a substituent other than H)), and an ureido group (provided that it does not have an>N—H group, but is blocked like an>N—Ra (Ra is a substituent other than H)).

Particularly preferred hydrogen bonding compounds are the compounds represented by the following formula (D): Formula (D)

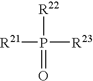

In the formula (D), R21 to R23 each independently represents an alkyl group, an aryl group, an alkoxy group, an aryloxy group, an amino group, or a heterocyclic group. These groups may be unsubstituted, or have a substituent. As the substituents when R21 to R23 have substituents, mention may be made of a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, a phosphoryl group, and the like. A preferred substituent is an alkyl group or an aryl group, examples of which may include: a methyl group, an ethyl group, an isopropyl group, a t-butyl group, a t-octyl group, a phenyl group, a 4-alkoxyphenyl group, and a 4-acyloxyphenyl group.

Specific examples of the alkyl group of R21 to R23 may include: a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group. Examples of an aryl group may include: a phenyl group, a cresyl group, a xylyl group, a naphthyl group, a 4-t-butylphenyl group, a 4-t-octylphenyl group, a 4-anisidyl group, and a 3,5-dichlorophenyl group. Examples of an alkoxy group may include: a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group. Examples of an aryloxy group may include: a phenoxy group, a cresyloxy group, an isopropylphenoxy group, a 4-t-butylphenoxy group, a naphthoxy group, and a biphenyloxy group. Examples of an amino group may include: a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

Each of R21 to R23 is preferably an alkyl group, an aryl group, an alkoxy group, or an aryloxy group. From the viewpoint of the effects of this embodiment, at least one of R21 to R23 is preferably an alkyl group or an aryl group, and two or more thereof are preferably alkyl groups or aryl groups. Whereas, R21 to R23 are preferably the same groups from the viewpoint of the availability at a low cost.

Specific examples of the hydrogen bonding compounds including the compound of the formula (D) in this embodiment will be shown, but this embodiment is not limited thereto.

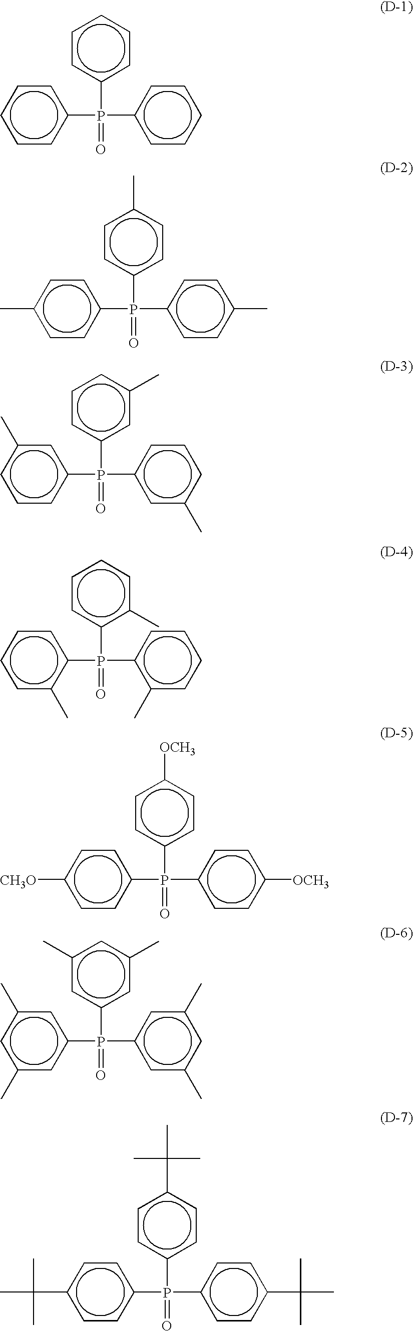

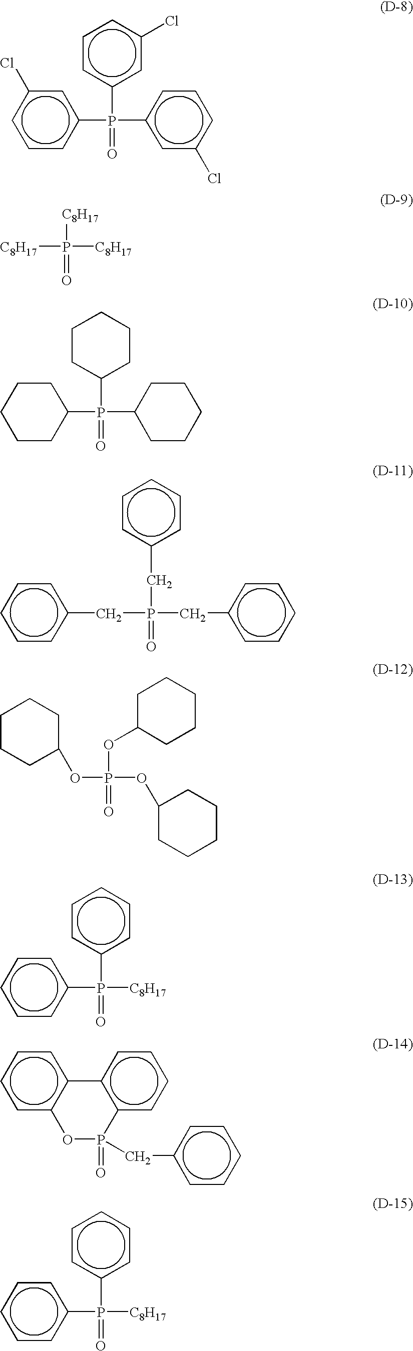

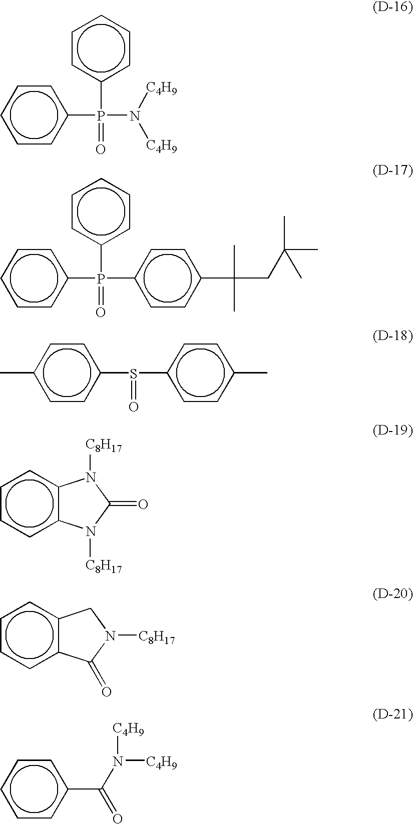

As the specific examples of the hydrogen bonding compound, other than the foregoing ones, mention may be made of those described in EP 1096310, and Japanese Patent Application Nos. 2000-270498 and 2001-124796.

The compound of the formula (D) in this embodiment can be used in the light-sensitive material by being incorporated into the coating solution in solution form, in emulsified dispersion form, or in solid dispersed fine particle dispersion form in the same manner as with the reducing agent. However, it is preferably used in solid dispersion form. The compound of this embodiment forms a hydrogen bonding complex with a compound having a phenolic hydroxyl group or an amino group in a solution state, so that it can be separated as a complex in a crystalline state, depending on the combination between the reducing agent and the compound of the formula (D) of this embodiment. It is particularly preferable for obtaining stable performances to use the crystal powder thus separated in the form of a solid dispersed fine particle dispersion. Further, methods of mixing the reducing agent with the compound of the formula (II) of this embodiment in a powder state, and then causing the formation of a complex during dispersing by means of a sand grinder mill, or the like with an appropriate dispersing agent can also preferably be used.

It is preferable that the compound of the formula (D) of this embodiment is used in an amount of preferably in the range of 1 to 200 mol %, more preferably in the range of 10 to 150 mol %, and further preferably in the range of 20 to 100 mol % based on the amount of the reducing agent.

(Explanation of Silver Halide)

The light-sensitive silver halide for use in this embodiment has no particular restriction as to the halogen composition. Silver chloride, silver chlorobromide, silver bromide, silver iodobromide, silver iodochlorobromide, and silver iodide can be used. Out of these, silver bromide and silver iodobromide are preferred. The distribution of halogen composition in a grain may be uniform, or it may be such that the halogen composition is stepwise changed or continuously changed. Further, silver halide grains having a core/shell structure can preferably be used. For the structure, a twofold to fivefold structure is preferable. Core/shell grains having a twofold to fourfold structure are more preferably used. Techniques of localizing silver bromide or silver iodide on the surface of silver chloride, silver bromide, or silver chlorobromide grain can also preferably be used.

The methods for forming the light-sensitive silver halide are well known in the art. For example, methods described in Research Disclosure No. 17029, June, 1978, and U.S. Pat. No. 3,700,458 can be used. Specifically, the following method is used. Namely, a silver-supplying compound and a halogen-supplying compound are added into a solution of gelatin or other polymers, thereby to prepare a light-sensitive silver halide. Then, the resulting light-sensitive silver halide is mixed with an organic silver salt. Further, the methods described in paragraph Nos. 0217 to 0224 of JP-A-11-119374, and the methods described in Japanese Patent Application No. 11-98708 and JP-A-2000-42335 are also preferred.

The grain size of the light-sensitive silver halide is preferably small for the purpose of suppressing the white turbidity after image formation to a low degree. Specifically, it is 0.20 μm or less, more preferably 0.01 μm or more and 0.15 μm or less, and further preferably 0.02 μm or more and 0.12 μm or less. The grain size herein mentioned denotes the diameter of the converted circular image having an area equivalent to the projection area of a silver halide grain (the projection area of the main plane for a tabular grain).

The silver halide grain may be in the shape of a cube, an octahedron, a tablet, a sphere, a rod, a potato, or the like. In this embodiment, cubic grains are particularly preferred. Silver halide grains with rounded corners can also preferably be used. The plane indices (Miller indices) of outer surface planes of light-sensitive silver halide grains have no particular restriction. However, [100] plane showing a high spectral sensitization efficiency upon adsorption of spectral sensitizing dyes thereon preferably occupies a large proportion. The proportion is preferably 50% or more, more preferably 65% or more, and furthermore preferably 80% or more. The proportion of Miller index [100] plane can be determined by the method described in T. Tani; J. Imaging Sci., 29, 165, (1985), which utilizes the adsorption dependency between [111] plane and [100] plane in the sensitizing dye adsorption.

In this embodiment, a silver halide grain having a hexacyano metal complex in the grain outermost surface is preferred. As the hexacyano metal complexes, mention may be made of [Fe(CN)₆]⁴—, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [RE(CN)₆]³⁻, and the like. In this embodiment, a hexacyano Fe complex is preferred.

The hexacyano metal complex exists in the form of an ion in an aqueous solution, and hence its counter cation is not important. However, the counter cations to be preferably used are alkali metal ions such as sodium ion, potassium ion, rubidium ion, cesium ion, and lithium ion, ammonium ion, and alkylammonium ion (e.g., tetramethylammonium ion, tetraethylammonium ion, tetrapropylammonium ion, and tetra(n-butyl)ammonium ion), which are readily miscible with water, and are suitable for the operation of precipitating silver halide emulsions.

The hexacyano-metal complex may be added by being incorporated in a mixed solvent of water, and in addition, an organic solvent miscible with water (e.g., alcohols, ethers, glycols, ketones, esters, or amides), or gelatin.

The amount of hexacyano-metal complex to be added is preferably 1×10⁻⁵ mol or more to 1×10⁻² mol or less, and more preferably 1×10⁻⁴ mol or more to 1×10⁻³ mol or less per mole of silver.

In order for the hexacyano-metal complex to exist in the outermost surfaces of silver halide grains, the hexacyano-metal complex is directly added after the completion of addition of an aqueous silver nitrate solution for use in grain formation, and before the completion of the charging step until prior to the chemical sensitization step of performing chalcogen sensitization such as sulfur sensitization, selenium sensitization or tellurium sensitization, or noble metal sensitization such as gold sensitization, during the water washing step, during the dispersing step, or before the chemical sensitization step. In order to prevent the growth of silver halide grains, the hexacyano-metal complex is preferably added immediately after grain formation, and preferably added before the completion of the charging step.

Incidentally, the addition of the hexacyano-metal complex may be started after adding 96 mass % of the total amount of silver nitrate to be added for grain formation. It is more preferably started after adding 98 mass % thereof, and in particular preferably after adding 99 mass % thereof.

When the hexacyano-metal complex is added just before the completion of the grain formation, and after the addition of an aqueous solution of silver nitrate, it can adsorbs onto the outermost surfaces of the silver halide grains. Most of them forms a slightly-soluble salt with the silver ions in the grain surfaces. The silver salt of hexacyano-iron (II) is more slightly soluble than AgI, which can prevent re-dissolving in the form of fine grains. This enables manufacturing of silver halide fine grains with a small grain size.

The light-sensitive silver halide grains of this embodiment can contain a metal of the Groups 8 to 10 in the Periodic Table (showing the Groups 1 to 18), or a metal complex thereof. The metals of the Groups 8 to 10 in the Periodic Table or the central metals of the metal complexes are preferably rhodium, ruthenium, and iridium. These metal complexes may be used alone, or in combination of two or more complexes of the same kind of metals and different kinds of metals. The preferred content is preferably in the range of 1×10⁻⁹ mol to 1×10⁻³ mol per mole of silver. These heavy metals, metal complexes, and addition processes thereof are described in JP-A-7-225449, JP-A-11-65021, paragraph Nos. 0018 to 0024, and JP-A-11-119374, paragraph Nos. 0227 to 0240.

Further, the metal atoms (e.g., [Fe(CN)₆]⁴⁻), desalting processes or chemical sensitizing process of a silver halide emulsion are described in JP-A-11-84574, paragraph Nos. 0046 to 0050, JP-A-11-65021, paragraph Nos. 0025 to 0031, and JP-A-11-119374, paragraph Nos. 0242 to 0250.

As the gelatins to be incorporated in the light-sensitive silver halide emulsion for use in this embodiment, various gelatins may be used. The dispersion state in an organic silver salt-containing coating solution of the light-sensitive silver halide emulsion is required to be kept favorable, so that gelatin having a molecular weight of 10,000 to 1,000,000 is preferably used. Whereas, it is also preferable to subject the substituent of gelatin to phthalation treatment. The gelatin may be used for grain formation or for dispersing after desalting treatment, but it is preferably used for grain formation.

As sensitizing dyes applicable to this embodiment, the sensitizing dyes can be advantageously selected which are capable of spectrally sensitizing silver halide grains in a desirable wavelength region upon adsorbing on the silver halide grains, and have the spectral sensitivities suitable for the spectral characteristics of an exposure light source. The sensitizing dyes and the addition processes thereof are described in the following references, or as the following substances: paragraph Nos. 0103 to 0109 of JP-A-11-65021, the compounds represented by the formula (II) in JP-A-10-186572, the dyes represented by the formula (I) and the paragraph No. 0106 of JP-A-11-119374, U.S. Pat. No. 5,510,236, the dyes described in Example 5 of U.S. Pat. No. 3,871,887, JP-A-2-96131, the dyes disclosed in JP-A-59-48753, on page 19, line 38 to page 20, line 35 of EP 0803764A1, Japanese Patent Application Nos. 2000-86865, 2000-102560, and 2000-205399, and the like. These sensitizing dyes may be used alone, or may also be used in combination of two or more thereof. In this embodiment, the timing of adding a sensitizing dye to a silver halide emulsion is preferably during the period after the desalting step until coating, and more preferably during the period after desalting until prior to the completion of chemical aging.

The amount of the sensitizing dye to be added in this embodiment can be set at a desirable amount according to the sensitivity and the fog performance. It is preferably 10⁻⁶ to 1 mol, and more preferably 10⁻⁴ to 10⁻¹ mol per mole of silver halide of the light-sensitive layer.

In this embodiment, it is possible to use a supersensitizer in order to improve the spectral sensitization efficiency. As the supersensitizers for use in this embodiment, mention may be made of the compounds described in EP 587,338, U.S. Pat. Nos. 3,877,943 and 4,873,184, JP-A-5-341432, JP-A-11-109547, JP-A-10-111543, and the like.

The light-sensitive silver halide grains in this embodiment are preferably subjected to chemical sensitization with a sulfur sensitization process, a selenium sensitization process, or a tellurium sensitization process. The compounds preferably usable for a sulfur sensitization process, a selenium sensitization process, or a tellurium sensitization process are known compounds. For example, the compounds described in JP-A-7-128768, and the like may be used. In particular, tellurium sensitization is preferred in this embodiment. The compounds described in the reference described in the paragraph No. 0030 of JP-A-11-65021, and the compounds represented by the formulae (II), (III), and (IV) in JP-A-5-313284 are more preferred.

The light-sensitive silver halide grains in this embodiment has been preferably chemically sensitized by a gold sensitization process, in combination with the chalcogen sensitization, or alone. The gold sensitizer preferably has a valence of gold of +1 or +3. Preferred gold sensitizers are normally used gold compounds. Typical preferred examples thereof include: chloroauric acid, bromoauric acid, potassium chloroaurate, potassium bromoaurate, auric trichloride, potassium auric trithiocyanate, potassium iodoaurate, tetracyanoauric acid, ammonium aurothiocyanate, and pyridyltrichlorogold. Further, the gold sensitizers described in U.S. Pat. No. 5,858,637 and Japanese Patent Application No. 2001-79450 are also preferably used.

In this embodiment, any timing is acceptable for the chemical sensitization so long as the timing is after grain formation and before coating. The timing may be after desalting, and (1) before spectral sensitization, (2) simultaneously with spectral sensitization, (3) after spectral sensitization, (4) immediately before coating, or the like.

Each amount of the sulfur, selenium, and tellurium sensitizers for use in this embodiment varies according to the silver halide grains to be used, the chemical aging conditions, and the like. Each sensitizer is used in an amount of about 10⁻⁸ to 10⁻² mol, and preferably 10⁻⁷ to 10⁻³ mol per mole of silver halide.

The amount of gold sensitizer to be added varies according to various conditions. It is, as a guideline, 10⁻⁷ mol to 10⁻³ mol, and more preferably 10⁻⁶ to 5×10⁻⁴ mol per mole of silver halide

The conditions for the chemical sensitization in this embodiment has no particular restriction. The pH is 5 to 8, the pAg is 6 to 11, and the temperature is about 40 to 95° C.

To the silver halide emulsion for use in this embodiment, a thiosulfonic acid compound may also be added with the method described in EP 293,917.

For the light-sensitive silver halide grains in this embodiment, a reducing agent is preferably used. As the specific compounds for a reduction sensitization process, ascorbic acid and thiourea dioxide are preferred. In addition, stannous chloride, aminoiminomethane sulfinic acid, hydrazine derivatives, borane compounds, silane compounds, polyamine compounds, and the like are preferably used. The reduction sensitizer may be added in the any process of the light-sensitive emulsion manufacturing steps of from the crystal growth until the preparation step immediately before coating. Whereas, the emulsion is preferably aged with the pH held at 7 or more, or with the pAg held at 8.3 or less, so that reduction sensitization is performed. The reduction sensitization is also preferably performed by introducing the single addition part of silver ion during grain formation.

The light-sensitive silver halide emulsion in this embodiment preferably contains a FED sensitizer (fragmentable electron donating sensitizer) as a compound generating two electrons with one photon. Preferred FED sensitizers are the compounds described in U.S. Pat. Nos. 5,747,235, 5,747,236, 6,054,260, and 5,994,051, and Japanese Patent Application No. 2001-86161. The step of adding a FED sensitizer is preferably performed in any process of the light-sensitive emulsion manufacturing steps of from the crystal growth until the preparation step immediately before coating. The amount of the sensitizer to be added varies according to various conditions. It is, as a guideline, 10⁻⁷ mol to 10⁻¹ mol, and more preferably 10⁻⁶ mol to 5×10⁻² mol per mole of silver halide

The light-sensitive silver halide emulsions in the light-sensitive material for use in this embodiment may be used alone, or in combination of two or more thereof (e.g., the ones having different average grain sizes, the ones having different halogen compositions, the ones having different crystal habits, and the ones requiring different conditions for chemical sensitization). By using a plurality of kinds of light-sensitive silver halides mutually different in sensitivity, it is possible to adjust the tone. As the techniques on these, mention may be made of JP-A-57-119341, JP-A-53-106125, JP-A-47-3929, JP-A-48-55730, JP-A-46-5187, JP-A-50-73627, JP-A-150841, and the like. As for the sensitivity difference, a difference of 0.2 logE or more is preferably caused between respective emulsions.

The amount of a light-sensitive silver halide to be added is preferably 0.03 to 0.06 g/m², more preferably 0.05 to 0.4 g/m², and most preferably 0.07 to 0.3 g/m² in terms of the coating amount of silver per square meter of the sensitive material. The light-sensitive silver halide is in an amount of preferably 0.01 mol or more and 0.5 mol or less, more preferably 0.02 mol or more and 0.3 mol or less, and further preferably 0.03 mol or more and 0.2 mol or less per mole of organic silver salt.

Regarding the mixing method and the mixing condition for separated prepared light-sensitive silver halide and organic silver salt, there is a method of mixing the silver halide grains and organic silver salt, which have been respectively prepared, in a high-speed stirrer, a ball mill, a sand mill, a colloid mill, a shaking mill, a homogenizer, or the like; a method of mixing the light-sensitive silver halide which has been prepared, in any timing during the preparation of an organic silver halide, and preparing organic silver halide; or other methods. However, there is no particular restriction thereon, so far as the effects of this embodiment are sufficiently produced. Whereas, for mixing, it is a preferable method for adjusting the photographic characteristics that two or more kinds of aqueous dispersions of organic silver salts and two or more kinds of aqueous dispersions of light-sensitive silver salts are mixed.

The preferred timing of adding the silver halide of this embodiment into an image forming layer coating solution is in the period of from 180 minutes before to immediately before, and preferably 60 minutes before to 10 seconds before coating. However, the mixing process and the mixing conditions have no particular restriction so long as the effects of this embodiment satisfactorily occur. As specific mixing processes, there are a method in which the mixing is performed in a tank configured such that the mean residence time therein calculated from the addition flow rate and the feeding amount to a coater becomes a desirable time; a method using a static mixer described in Chapter 8 of Ekitai Kongo Gijutsu written by N. Harnby, M. F. Edwards, and A. W. Nienow, translated by Koji Takahashi, (published by Nikkan Kogyo Shinbunsha, 1989); and the like.

(Explanation of Binder)

The usable binder in the organic silver salt-containing layer of this embodiment may be any polymer. Preferred binders are transparent or semi-transparent, and generally colorless, and include natural resins, or polymers and copolymers, synthetic resins, or polymers and copolymers, and other media which form a film, such as gelatins, rubbers, poly(vinyl alcohol)s, hydroxyethyl celluloses, cellulose acetates, cellulose acetate butylates, poly(vinylpyrrolidone)s, casein, starch, poly(acrylic acid)s, poly(methylmethacrylic acid)s, poly(vinyl chloride)s, poly(methacrylic acid)s, styrene-maleic anhydride copolymers, styrene-acrylonitrile copolymers, styrene-butadiene copolymers, poly(vinyl acetal)s (e.g., poly(vinyl formal) and poly(vinyl butyral)), poly(ester)s, poly(urethane)s, phenoxy resins, poly(vinylidene chloride)s, poly(epoxide)s, poly(carbonate)s, poly(vinyl acetate)s, poly(olefin)s, cellulose esters, and poly(amide)s. The binders may be coated after being dissolved in water or an organic solvent, or in the form of an emulsion for film formation.

In this embodiment, the glass transition temperature of the binder usable in combination in the organic silver salt-containing layer is preferably 10° C. or more and 80° C. or less (hereinafter, may be referred to as a high Tg binder), more preferably 15° C. to 70° C., and further preferably 20° C. or more and 65° C. or less. Incidentally, in this specification, the Tg was calculated with the following equation.

1/Tg=Σ(Xi/Tgi)

In this case, it is assumed that the polymer is formed by copolymerization of n monomer components from i=1 to n. Xi denotes the weight ratio of the i-th monomer (ΣXi=1), and Tgi denotes the glass transition temperature (an absolute temperature) of the homopolymer of the i-th monomer, provided that Σ is the sum for from i=1 to i=n. Incidentally, for the value (Tgi) of the glass transition temperature of the homopolymer of each monomer, the values described in Polymer Handbook, (3rd Edition) (written by J. Brandiup and E. H. Immergut, (Willey-interscience, 1989)), have been adopted.

The binders may be used, if required, in combination of two or more thereof. Alternatively, the one having a glass transition temperature of 20° C. or more and the one having a glass transition temperature of lower than 20° C. may also be used in combination. When two or more kinds of polymers having different Tg values are blended to be used, it is preferable that the weight average Tg thereof falls within the foregoing range.

In this embodiment, an organic silver salt-containing layer is preferably formed as a coating film through coating and drying using a coating solution in which 30 mass % or more of the solvent is water.

In this embodiment, the performances are improved when coating is performed with a coating solution in which 30 mass % or more of the solvent is water, followed by drying to form the organic silver salt-containing layer, further when the binder in the organic silver salt-containing layer is soluble or dispersible in an aqueous solvent (a water solvent), and, in particular, when the binder comprises a latex of polymer having an equilibrium moisture content at 25° C. and 60% RH of 2 mass % or less. The most preferable form is such that preparation has been performed so as to obtain an ionic conductivity of 2.5 mS/cm or less. For such a preparation method, mention may be made of a purification treatment method using a functional membrane for separation after synthesizing a polymer.

The aqueous solvent mentioned here in which the polymer is soluble or dispersible means water or a mixture of water and a water-miscible organic solvent in an amount of 70 mass % or less. Examples of the water-miscible organic solvent may include: alcohol type solvents such as methyl alcohol, ethyl alcohol, and propyl alcohol, cellosolve type solvents such as methyl cellosolve, ethyl cellosolve, and butyl cellosolve, ethyl acetate and dimethyl formamide.

Incidentally, the term “the aqueous solvent” is used also for a system where a polymer is not thermodynamically dissolved, but exists in a so-called dispersed state.

Whereas, “the equilibrium moisture content at 25° C. and 60% RH” can be expressed by using the weight W1 of a polymer in an equilibrium with moisture conditioning under an atmosphere of 25° C. and 60% RH, and the weight W0 of the polymer in an absolutely dry state, as the following equation.

Equilibrium moisture content at 25° C. and 60% RH=[(W1-W0)/W0]×100 (mass %)

As for the definition and the measurement method of moisture content, for example, Polymer Engineering Course 14, Testing Methods of Polymer Materials (compiled by the Society of Polymer Science of Japan, Chijin Shokan) can serve as a reference.

The equilibrium moisture content at 25° C. and 60% RH of the binder polymer of this embodiment is preferably 2 mass % or less, more preferably 0.01 mass % or more and 1.5 mass % or less, and furthermore preferably 0.02 mass % or more and 1 mass % or less.

In this embodiment, a polymer dispersible in an aqueous solvent is particularly preferred. Acceptable examples of the dispersion state may include any of the dispersion state for a latex in which fine particles of a water-insoluble and hydrophobic polymer are dispersed, or the dispersion state for the one in which polymer molecules are dispersed in a molecular state or a micelle-forming state. However, dispersed particles in a latex are more preferred. The average particle diameter of dispersed particles is 1 to 50000 nm, preferably in the range of 5 to 1000 nm, more preferably in the range of 10 nm to 500 nm, and furthermore preferably in the range of 50 to 200 nm. The particle diameter distribution of the dispersed particles has no particular restriction. Both of dispersed particles having a broad particle diameter distribution or dispersed particles having a monodisperse particle diameter distribution are acceptable. It is also a preferred method in terms of controlling the physical properties of the coating solution to use the ones having a monodisperse particle diameter distribution in mixture of two or more kinds thereof.

In this embodiment, as the preferred embodiments of the polymer dispersible in an aqueous solvent, hydrophobic polymers such as acrylic polymers, poly(ester)s, rubbers (e.g., SBR resins), poly(urethane)s, poly(vinyl chloride)s, poly(vinyl acetate)s, poly(vinylidene chloride)s, and poly(olefin)s can preferably be used. These polymers may be straight chain polymers or branched chain polymers, and may be cross-linked polymers, so-called homopolymers in which a single kind of monomers are polymerized, or copolymers in which two or more kinds of monomers are polymerized. For a copolymer, it may be either of a random copolymer or a block copolymer. Each molecular weight of these polymers is 5,000 to 1,000,000, and preferably 10,000 to 200,000 in terms of the number average molecular weight. When a polymer having a too small molecular weight is used, the mechanical strength of the resulting emulsion layer is insufficient. When a polymer having a too large molecular weight is used, the film forming properties are inferior. Both of these cases are not preferable. Whereas, cross-linkable polymer latexes are in particular preferably used.

(Specific Examples of Latex)

Specific examples of a preferred polymer latex may include the following ones. Below, they are expressed with the raw material monomers. Each numerical value parenthesized denotes the amount in terms of mass %, and the molecular weights are the number average molecular weights. When multi-functional monomers have been used, the concept of molecular weight can not be applied, because crosslinked structures are formed. Accordingly, such a case is described as “(crosslinkable)” to omit the description of molecular weight. Tg denotes the glass transition temperature.

P-1; Latex of -MMA(70)-EA(27)-MAA(3)-(molecular weight: 37000, Tg: 61° C.)

P-2; Latex of -MMA(70)-2-EHA(20)-St(5)-AA(5)-(molecular weight: 40000, Tg: 59° C.)

P-3; Latex of -St(50)-Bu(47)-MMA(3)-((crosslinkable), Tg: −17° C.))

P-4; Latex of -St(68)-Bu(29)-AA(3)-((crosslinkable), Tg: 17° C.))

P-5; Latex of -St(71)-Bu(26)-AA(3)-((crosslinkable), Tg: 24° C.))

P-6; Latex of -St(70)-Bu(27)-IA(3)-((crosslinkable))

P-7; Latex of -St(75)-Bu(24)-AA(1)-((crosslinkable), Tg: 29° C.)

P-8; Latex of -St(60)-Bu(35)-DVB(3)-MAA(2)-((crosslinkable))

P-9; Latex of -St(70)-Bu(25)-DVB(2)-AA(3)-((crosslinkable))

P-10; Latex of -VC(50)-MMA(20)-EA(20)-AN(5)-AA(5)-(molecular weight: 80000)

P-11; Latex of -VDC(85)-MMA(5)-EA(5)-MAA(5)-(molecular weight: 67000)

P-12; Latex of -Et(90)-MAA(10)-(molecular weight: 12000)

P-13; Latex of -St(70)-2-EHA(27)-AA(3)-(molecular weight: 130000, Tg: 43° C.))

P-14; Latex of -MMA(63)-EA(35)-AA(2)-(molecular weight: 33000, Tg: 47° C.)

P-15; Latex of -St(70.5)-Bu(26.5)-AA(3)-((crosslinkable), Tg: 23° C.)

P-16; Latex of -St(69.5)-Bu(27.5)-AA(3)-((crosslinkable), Tg: 20.5° C.)

The abbreviations of the foregoing structures denote the following monomers. MMA; methyl methacrylate, EA; ethyl acrylate, MAA; methacrylic acid, 2-EHA; 2-ethylhexyl acrylate, St; styrene, Bu; butadiene, AA; acrylic acid, DVB; divinylbenzene, VC; vinyl chloride, AN; acrylonitrile, VDC: vinylidene chloride, Et; ethylene, and IA; itaconic acid.

The foregoing polymer latexes are also commercially available, and the following polymers are available. Examples thereof may include: acrylic polymers such as CEVIAN A-4635, 4718, and 4601 (manufactured by DAICEL Chemical Industries, Ltd), and Nipol Lx811, 814, 821, 820, and 857 (all manufactured by Nippon Zeon Co., Ltd.); poly(ester)s such as FINETEX ES650, 611, 675, and 850 (all manufactured by Dai-Nippon Ink & Chemicals, Inc. Ltd.), WD-size, and WMS (both manufactured by Eastman Chemical); poly(urethane)s such as HYDRAN AP10, 20, 30, and 40 (all manufactured by Dai-Nippon Ink & Chemicals, Inc., Ltd.); rubbers such as LACSTAR 7310K, 3307B, 4700H, and 7132C (all manufactured by Dai-Nippon Ink & Chemicals, Inc., Ltd.), and Nipol Lx416, 410, 438c, and 2507 (all manufactured by Nippon Zeon Co., Ltd.); (vinyl chloride)s such as G351 and G576 (both manufactured by Nippon Zeon Co., Ltd.); (vinylidene chloride)s such as L502 and L513 (both manufactured by Asahi Chemical Industry Co., Ltd); and poly(olefin)s such as CHEMIPEARL S120 and SA100 (both manufactured by Mitsui Photochemicals, Industries, Ltd.).

These polymer latexes may be used alone, or if required, in a blend of two or more thereof.

(Preferred Latexes)

As the polymer latex for use in this embodiment, The latex of a styrene-butadiene copolymer is particularly preferred. The weight ratio of styrene monomer units to butadiene monomer units in the styrene-butadiene copolymer preferably falls within a range of 40:60 to 95:5. Also preferably, the proportion occupied by the styrene monomer units and the butadiene monomer units in the copolymer is 60 to 99 mass %. Whereas, the polymer latex of this embodiment contains an acrylic acid or a methacrylic acid in an amount of preferably 1 to 6 mass %, and more preferably 2 to 5 mass % relative to the sum of the amounts of styrene and butadiene. The polymer latex of this embodiment preferably contains an acrylic acid.

As the styrene-butadiene-acid copolymer latexes to be preferably used in this embodiment, mention may be made of the above-mentioned P-3 to P-8, and P-15, and commercially available products, LACSTAR-3307B and -7132C, Nipol Lx416, and the like.

To an organic silver salt-containing layer of the light-sensitive material of this embodiment, if required, a hydrophilic polymer such as gelatin, polyvinyl alcohol, methyl cellulose, hydroxypropyl cellulose, or carboxymethyl cellulose may also be added. The amount of the hydrophilic polymer to be added is 30 mass % or less, and more preferably 20 mass % or less based on the total amount of the binder in the organic silver salt-containing layer.

The organic silver salt-containing layer (i.e., image-forming layer) of this embodiment is preferably the one formed using a polymer latex. The amount of binder in the organic silver salt-containing layer is such that the weight ratio of total binder/organic silver salt falls within a range of 1/10 to 10/1, more preferably in the range of 1/3 to 5/1, and furthermore preferably in the range of 1/1 to 3/1.

Further, such an organic silver salt-containing layer is also, in general, the light-sensitive layer (emulsion layer) containing light-sensitive silver halide which is a light-sensitive silver salt. The weight ratio of total binder/silver halide in such a case is in the range of 400 to 5, and more preferably 200 to 10.

The total amount of binder in the image-forming layer of this embodiment is in the range of preferably 0.2 to 30 g/m², more preferably 1 to 15 g/m², and furthermore preferably 2 to 10 g/m². To the image-forming layer of this embodiment, a crosslinking agent for crosslinking, a surfactant for improving the coatability, and the like may also be added.

(Preferred Solvent of Coating Solution)

In this embodiment, the solvent of the coating solution of an organic silver salt-containing layer of the light-sensitive material (herein, for simplification, solvents and dispersion media are both together referred to as solvents) is preferably an aqueous solvent containing water in an amount of 30 mass % or more. As a component except for water, a given water-miscible organic solvent such as methyl alcohol, ethyl alcohol, isopropyl alcohol, methyl cellosolve, ethyl cellosolve, dimethylformamide, or ethyl acetate may also be used. The water content of the solvent of the coating solution is preferably 50 mass % or more, and more preferably 70 mass % or more. Preferred examples of the solvent composition include, other than water, water/methyl alcohol=90/10, water/methyl alcohol=70/30, water/methyl alcohol/dimethylformamide=80/15/5, water/methyl alcohol/ethyl cellosolve=80/10/5, and water/methyl alcohol/isopropyl alcohol=85/10/5, (each numerical value is expressed in terms of mass %).

(Explanation of Anti-Fogging Agent)

As anti-fogging agents, stabilizers and stabilizer precursors usable in this embodiment, mention may be made of the ones of patent described in paragraph No. 0070 of JP-A-10-62899, and from page 20, line 57 to page 21, line 7 of EP 0803764A1, the compounds of JP-A-9-281637 and JP-A-9-329864, and the compounds described in U.S. Pat. Nos. 6,083,681 and 6,083,681, and EP 1048975. Whereas, the anti-fogging agents to be preferably used in this embodiment are organic halides. As for these, mention may be made of the ones disclosed in patent described in paragraph Nos. 01110 to 0112 of JP-A-11-65021. Particularly preferred are the organic halogen compounds represented by the formula (P) in JP-A-2000-284399, the organic polyhalogen compounds represented by the formula (II) in JP-A-10-339934, and the organic polyhalogen compounds described in JP-A-2001-31644 and JP-A-2001-33911.

(Explanation of Polyhalogen Compound)

Below, preferred organic polyhalogen compounds in this embodiment will be described specifically. The preferred organic polyhalogen compounds in this embodiment are the compounds represented by the following formula (H):

Formula (H)

Q.(Y)n.C(Z1)(Z2)X

In the formula (H), Q denotes an alkyl group, an aryl group, or a heterocyclic group, Y denotes a divalent bonding group, n denotes 0 or 1, Z1 and Z2 denote halogen atoms, and X denotes a hydrogen atom or an electron-attracting group.

In the formula (H), Q is preferably an aryl group or a heterocyclic group.

In the formula (H), when Q is a heterocyclic group, a nitrogen-containing heterocyclic group having one or two nitrogen atoms are preferred, and a 2-pyridyl group and a 2-quinolyl group are particularly preferred.

In the formula (H), when Q is an aryl group, Q denotes a phenyl group substituted by an electron-attracting group in which preferably the Hammet's substituent constant σp takes on a positive value. With regard to Hammett's substituent constant, Journal of Medicinal Chemistry, 1973, Vol. 16, No. 11, pp. 1207 to 1216, or the like can serve as a reference. Examples of such an electron-attracting group may include: a halogen atom (fluorine atom (σp value: 0.06), chlorine atom (σp value: 0.23), bromine atom (σp value: 0.23), iodine atom (σp value: 0.18), trihalomethyl groups (tribromomethyl (σp value: 0.29), trichloromethyl (σp value: 0.33), and trifluoromethyl (σp value: 0.54)), a cyano group (σp value: 0.66), a nitro group (σp value: 0.78), an aliphatic-aryl or heterocyclic sulfonyl group (e.g., methanesulfonyl σp value: 0.72)), an aliphatic-aryl or heterocyclic acyl group (e.g., acetyl σp value: 0.50), benzoyl σp value: 0.43), an alkynyl group (e.g., C≡CH (up value: 0.23), aliphatic-aryl or heterocyclic oxycarbonyl groups (e.g., methoxycarbonyl σp value: 0.45) and phenoxycarbonyl σp value: 0.44)), a carbamoyl group (up value: 0.36), a sulfamoyl group σp value: 0.57), a sulfoxide group, a heterocyclic group, and a phosphoryl group. The σp value is preferably in the range from 0.2 to 2.0, and more preferably in the range from 0.4 to 1.0. Particularly preferred electron-attracting groups are a carbamoyl group, an alkoxycarbonyl group, an alkylsulfonyl group, and an alkylphosphoryl group. Out of these, a carbamoyl group is most preferred.

X is preferably an electron-attracting group, and more preferably a halogen atom, an aliphatic-aryl or heterocyclic sulfonyl group, an aliphatic-aryl or heterocyclic acyl group, an aliphatic-aryl or heterocyclic oxycarbonyl group, a carbamoyl group, or a sulfamoyl group. In particular, a halogen atom is preferred. Out of the halogen atoms, a chlorine atom, a bromine atom, and an iodine atom are preferred, a chlorine atom and a bromine atom are more preferred, and a bromine atom is particularly preferred.

Y preferably denotes —C(═O)—, —SO—, or —SO₂—, more preferably —C(═O)—or —SO₂—, and in particular preferably —SO₂—. n denotes 0 or 1, and preferably 1.

Below, specific examples of the compound of the formula (H) of this embodiment will be shown.

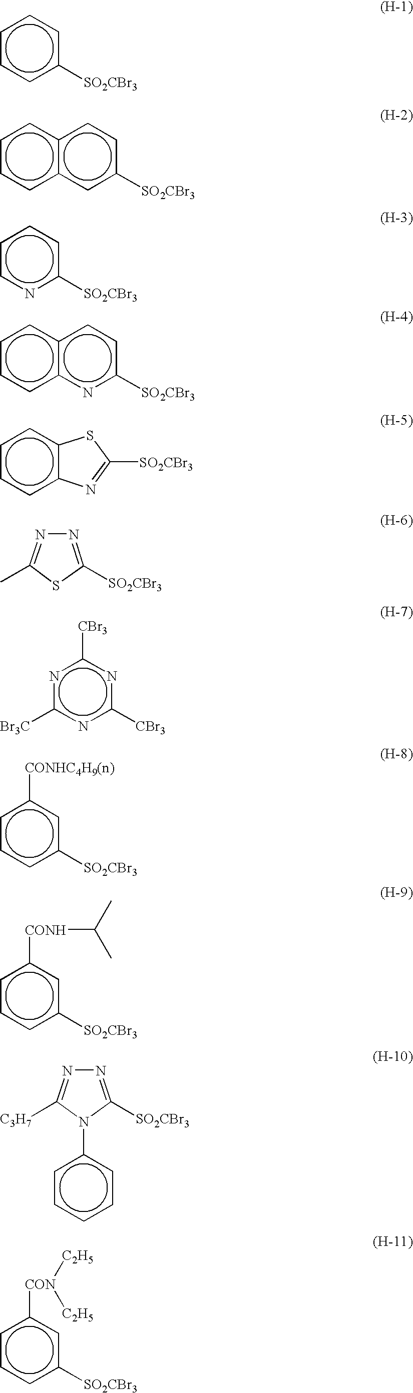

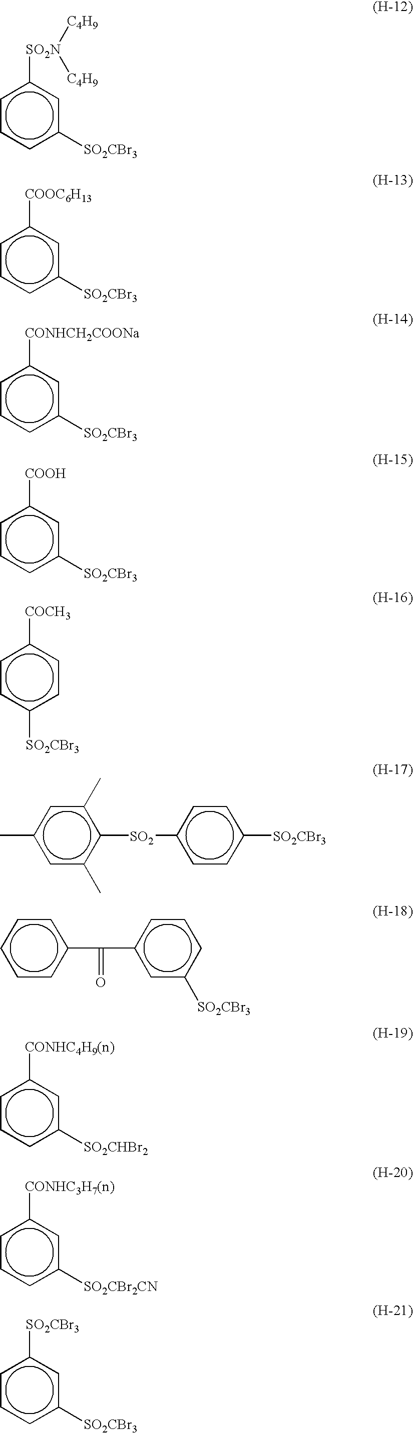

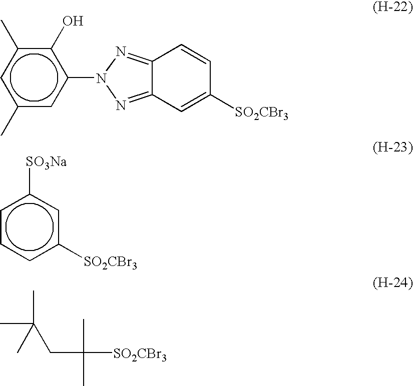

The compound represented by the formula (H) of this embodiment is used in an amount of, preferably in the range of 10⁻⁴ to 1 mol, more preferably in the range of 10⁻³ to 0.5 mol, and furthermore preferably in the range of 1×10⁻² mol to 0.2 mol per mole of non-light-sensitive silver salt in the image-forming layer.

In this embodiment, as a method for incorporating an anti-fogging agent into a light-sensitive material, mention may be made of the method described in connection with the incorporation method of the reducing agent. Also for the organic polyhalogen compound, it is preferably added in the form of a solid fine particle dispersion.

(Other Anti-Fogging Agents)

As other anti-fogging agent, mention may be made of mercury (II) salt in paragraph No. 0113 of JP-A-11-65021, benzoic acids in paragraph No. 0114, ibid., salicylic acid derivatives in JP-A-2000-206642, formalin scavenger compounds represented by the formula (S) in JP-A-2000-221634, triazine compounds according to claim 9 of JP-A-11-352624, the compounds represented by the formula (III) in JP-A-6-11791, 4-hydroxy-6-methyl-1,3,3a,7-tetrazaindene, and the like.

The photothermographic material in this embodiment may contain an azolium salt for the purpose of inhibiting fogging. As the azolium salts, mention may be made of the compounds represented by the formula (XI) described in JP-A-59-193447, the compounds described in JP-B-55-12581, and the compounds represented by the formula (II) described in JP-A-60-153039. The azolium salt may be added to the light-sensitive material at any site. As for the addition layer, the azolium salt is preferably added to the layer on the side having a light-sensitive layer, and more preferably added to an organic silver salt-containing layer. The timing of adding an azolium salt may be during any steps of the preparation of a coating solution. When the azolium salt is added in the organic silver salt-containing layer, the timing may be during any steps between the preparation of the organic silver salt and the preparation of the coating solution, and it is preferably from after the preparation of the organic silver salt until immediately before coating. The azolium salt may be added by any process in which it is added in the form of a power, a solution a fine particle dispersion, or the like. Alternatively, it may also be added in the form of a solution of mixture with other additives such as a sensitizing dye, a reducing agent, and a toning agent. The amount of the azolium salt to be added in this embodiment may be any amount. However, it is preferably 1×10⁻⁶ mol or more and 2 mol or less, and more preferably 1×10⁻³ mol or more and 0.5 mol or less per mole of silver.

The photothermographic material of this embodiment may contain a mercapto compound, a disulfide compound, or a thione compound in order to inhibit or accelerate development, thereby controlling the development, to enhance the spectral sensitization efficiency, to improve the storage stability before and after development, or for other purposes. Examples thereof include the compounds disclosed in paragraph Nos. 0067 to 0069 of JP-A-10-62899, the compounds represented by the formula (I), and the specific examples thereof described in paragraph Nos. 0033 to 0052 of JP-A-10-186572, and those described on page 20, lines 36 to 56 of EP 0803764A1. Out of these, the mercapto-substituted heterocyclic aromatic compounds described in JP-A-9-297367, JP-A-9-304875, JP-A-2001-100358, and Japanese Patent Application Nos. 2001-104213 and 2001-104214 are preferred.

(Explanation of Toning Agent)

In the photothermographic material of this embodiment, it is preferable to add a toning agent. The toning agent is described in paragraph Nos. 0054 to 0055 of JP-A-10-62899, on page 21, lines 23 to 48 of EP 0803764A1, JP-A-2000-356317, and Japanese Patent Application No. 10-187298. In particular, preferred are phthalazinones (phthalazinone, phthalazinone derivatives, or metal salts; e.g., 4-(l-naphthyl)phthalazinone, 6-chlorophthalazinone, 5,7-dimethoxy phthalazinone, and 2,3-dihydro-1,4-phthalazinedion); combinations of phthalazinones and phthalic acids (e.g., phthalic acid, 4-methylphthalic acid, 4-nitrophthalic acid, diammonium phthalate, sodium phthalate, potassium phthalate, and tetrachlorophthalic anhydride); phthalazines (phthalazine, phthalazine derivatives, or metal salts; e.g., 4-(1-naphthyl) phthalazine, 6-isopropyl phthalazine, 6-t-butyl phthalazine, 6-chlorophthalazine, 5,7-dimethoxy phthalazine, and 2,3-dihydrophthalazine); and combinations of phthalazines and phthalic acids. Particularly, combinations of phthalazines and phthalic acids are preferred. Out of these, a particularly preferred combination is a combination of 6-isopropyl phthalazine and phthalic acid or 4-methylphthalic acid.

(Other Additives)

The plasticizers and the lubricants usable for the light-sensitive layer of this embodiment are described in paragraph No. 0117 of JP-A-11-65021. The ultrahigh contrast agents for forming ultrahigh contrast images, and the incorporation process and the amount thereof are described in paragraph No. 0118 of the same publication, paragraph Nos. 0136 to 0193 of JP-A-11-223898, as the compounds of the formula (H), the formulae (1) to (3), and the formulae (A) and (B) of JP-A-2000-284399, and as the compounds of the formulae (III) to (V) described in Japanese Patent Application No. 11-91652 (specific compounds: chemical formulae 21 to 24). The hardness enhancement promoters are described in paragraph No. 0102 of JP-A-11-65021, and paragraph Nos. 0194 and 0195 of JP-A-11-223898.

In order to use formic acid or a formic acid salt as a strongly fogging substance, it is preferably contained on the side having the image-forming layer containing a light-sensitive silver halide in an amount of 5 mmol or less, and more preferably 1 mmol or less, per mole of silver.

When an ultrahigh contrast agent is used in the photothermographic material of this embodiment, an acid formed by hydration of diphosphorus pentoxide or a salt thereof is preferably used in combination. Examples of the acid formed by hydration of diphosphorus pentoxide or a salt thereof may include metaphosphoric acid (salt), pyrophosphoric acid (salt), orthophosphoric acid (salt), triphosphoric acid (salt), tetraphosphoric acid (salt), and hexametaphosphoric acid (salt). Examples of acids formed by hydration of diphosphorus pentoxide or salts thereof, to be in particular preferably used may include orthophosphoric acid (salt) and hexametaphosphoric acid (salt). Specific examples of the salt include sodium orthophosphate, sodium dihydrogen orthophosphate, sodium hexametaphosphate, and ammonium hexametaphosphate.

The amount of the acid formed by hydration of diphosphorus pentoxide or a salt thereof to be used (the coating amount per square meter of the light-sensitive material) may be a desirable amount according to the performances including sensitivity, fog, and the like. However, it is preferably 0.1 to 500 mg/m², and more preferably 0.5 to 100 mg/m².

(Explanation of Layer Configuration)

The photothermographic material in this embodiment may be provided with a surface protective layer for the purpose of preventing adhesion of the image-forming layer, and for other purposes. The surface protective layer may be formed in a monolayered structure or in a multilayered structure. The surface protective layer is described in paragraph Nos. 0119 to 0120 of JP-A-11-65021, and Japanese Patent Application No. 2000-17936.

As the binder for the surface protective layer of this embodiment, gelatin is preferred. It is also preferably to use polyvinyl alcohol (PVA), or to use it in combination. Usable gelatin is inert gelatin (e.g., Nitta gelatin 750), phthalated gelatin (e.g., Nitta gelatin 801), or the like. As PVA, mention may be made of the ones described in paragraph Nos. 0009 to 0020 of JP-A-2000-171936. Preferably, mention may be made of PVA-105 of a completely saponified product, PVA-205 and PVA-335 of partially saponified products, and MP-203 of modified polyvinyl alcohol (all are trade names from Kuraray Co., Ltd.), and the like. The coating amount (per square meter of the support) of polyvinyl alcohol of the protective layer (per one layer) is preferably 0.3 to 4.0 g/m², and more preferably 0.3 to 2.0 g/m².

When the photothermographic material of this embodiment is used for printing use in which dimensional change is critical, polymer latex is preferably used in a surface protective layer or a back layer. Such a polymer latex is described in Gosei Jushi Emulsion, compiled by Taira Okuda and Hiroshi Inagaki, issued by Kobunshi Kanko Kai (1978); Gosei Latex no Ovo, compiled by Takaaki Sugimura, Yasuo Kataoka, Souichi Suzuki and Keishi Kasahara, issued by Kobunshi Kanko Kai (1993); Gosei Latekkusu no Kagaku (written by Soichi Muroi, issued by Kobunshi Kanko Kai (1970)), and the like. Specific example thereof may include latex of methyl methacrylate (33.5 mass %)/ethyl acrylate (50 mass %)/methacrylic acid (16.5 mass %) copolymer, latex of methyl methacrylate (47.5 mass %)/butadiene (47.5 mass %)/itaconic acid (5 mass %) copolymer, latex of ethyl acrylate/methacrylic acid copolymer, latex of methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer, and latex of methyl methacrylate (64.0 mass %)/styrene (9.0 mass %)/butyl acrylate (20.0 mass %)/2-hydroxyethyl methacrylate (5.0 mass %)/acrylic acid (2.0 mass %) copolymer. Further, as the binder for the surface protective layer, the combination of polymer latexes described in Japanese Patent Application No. 11-6872, the technique described in paragraph Nos. 0021 to 0025 of Japanese Patent Application No. 11-143058, the technique described in paragraph Nos. 0027-0028 of Japanese Patent Application No. 11-6872, and the technique described in paragraph Nos. 0023 to 0041 of Japanese Patent Application No. 10-199626 may also be applied. The ratio of the polymer latex of the surface protective layer is preferably 10 mass % or more and 90 mass % or less, and in particular preferably 20 mass % or more and 80 mass % or less based on the total amount of binder.

The coating amount (per square meter of the support) of the total binder (including a water-soluble polymer and a latex polymer) for the surface protective layer (per one layer) is preferably 0.3 to 5.0 g/m², and more preferably 0.3 to 2.0 g/m², The preparation temperature of the image-forming layer coating solution of this embodiment is preferably 30° C. or more and 65° C. or less. The more preferable temperature is 35° C. or more and less than 60° C. The furthermore preferable temperature is 35° C. or more and 55° C. or less. Whereas, the temperature of the image-forming layer coating solution immediately after the addition of a polymer latex is preferably kept at 30° C. or more and 65° C. or less.

The image-forming layer of this embodiment is composed of one or more layers on a support. When it is composed of a single layer, the layer comprises an organic silver salt, light-sensitive silver halide, a reducing agent, and a binder, and if required, contains desired additional materials such as a toning agent, a coating aid, and other auxiliary agents. When the layer is composed of two or more layers, a first image-forming layer (in general, the layer adjacent to the support) must contain therein an organic silver salt and silver halide, and a second image-forming layer or the both layers must contain therein some other ingredients. A multicolor light-sensitive photothermographic material is configured such that it may contain a combination of these two layers for each color, or may contain all ingredients in a single layer as described in U.S. Pat. No. 4,708,928. As for multiple-dye multicolor light-sensitive photothermographic material, respective emulsion layers are kept in such a relation as to be distinct from each other by using a functional or non-functional barrier layer between the respective light-sensitive layers as described in U.S. Pat. No. 4,460,681.

For the light-sensitive layer of this embodiment, various dyes and pigments (e.g., C.I. Pigment Blue 60, C.I. Pigment Blue 64, and C.I. Pigment Blue 15:6) can be used from the viewpoints of improving the color tone, preventing the formation of interference fringes during laser exposure, and preventing the irradiation. These are described in details in WO98/36322, JP-A-10-268465, and JP-A-11-338098.

In the photothermographic material of this embodiment, an antihalation layer can be disposed in a distant position from a light source relative to the light-sensitive layer.

The photothermographic materials generally have non-light-sensitive layers in addition to the light-sensitive layers. The non-light-sensitive layers can be classified according to their positions into (1) a protective layer to be provided on a light-sensitive layer (on the side more distant from the support); (2) an intermediate layer to be provided between a plurality of light-sensitive layers or between a light-sensitive layer and a protective layer; (3) an undercoat layer to be provided between a light-sensitive layer and a support; and (4) a back layer to be provided on the side opposite to the light-sensitive layer. A filter layer is provided in the light-sensitive material as the layer (1) or (2). The antihalation layer is provided in the light-sensitive material as the layer (3) or (4).

The antihalation layer is described in paragraph Nos. 0123 to 0124 of JP-A-11-65021, JP-A-11223898, JP-A-9-230531, JP-A-10-36695, JP-A-10-104779, JP-A-11-231457, JP-A-11-352625, JP-A-11-352626, and the like.

The antihalation layer contains an atihalation dye having an absorption in the exposure wavelength. When the exposure wavelength falls within the infrared region, an infrared-absorbing dye is desirably used. In such a case, the dye having no absorption in the visible region is preferred.

When antihalation is achieved using a dye having an absorption in the visible region, it is preferably configured such that the color of the dye will not substantially remain after image formation; a means for performing decolorizing by the heat from heat development is preferably used; and in particular, a heat decolorizable dye and a base precursor are preferably added to a non-light-sensitive layer so that the layer functions as an antihalation layer. These techniques are described in JP-A-11-231457, and the like.

The amount of the decolorizable dye to be added is determined according to the intended purpose of the dye. In general, the dye is used in an amount such that the optical density (absorbance) measured at an intended wavelength is more than 0.1. The optical density is preferably 0.15 to 2, and more preferably 0.2 to 1. The amount of the dye to be used for obtaining such an optical density is generally about 0.001 to about 1 g/m².

Incidentally, when the dye is decolorized in this manner, it is possible to lower the optical density after heat development to 0.1 or less. Two or more kinds of decolorizable dyes may also be used in combination in the heat decolorizing type recording materials or the photothermographic materials. Similarly, two or more kinds of base precursors may also be used in combination.

In heat decolorization using such a decolorizable dye and the base precursor, it is preferable to use a substance (e.g., diphenylsulfone, or 4-chlorophenyl (phenyl) sulfone) which decreases the melting point by 3° C. (deg) or more when mixed with the base precursor as described in JP-A-11-352626, 2-naphtyl benzoate, or the like, in combination, from the viewpoint of the heat decolorization property, and the like.

In this embodiment, a coloring agent having an absorption maximum at 300 to 450 nm can be added for the purposes of improving the silver color tone, and the change with time of images. Such coloring agents are described in JP-A-62-210458, JP-A-63-104046, JP-A-63-103235, JP-A-63-208846, JP-A-63-306436, JP-A-63-314535, JP-A-01-61745, and JP-A-2001-100363, and the like.

Such a coloring agent is generally added in an amount in the range of 0.1 mg/m² to 1 g/m². As a layer to which it is added, a back layer disposed on the opposite side of the light-sensitive layer is preferred.

The photothermagraphic material in this embodiment is preferably a so-called one-sided light-sensitive material having at least one layer of a light-sensitive layer containing a silver halide emulsion on one side of the support and having a back layer on the other side.

(Explanation of Matting Agent)

In this embodiment, it is preferable to add a matting agent for improving the transportability. The matting agents are described in paragraph Nos. 0126 to 0127 of JP-A-11-65021. The matting agent is coated in an amount of preferably 1 to 400 mg/m², and more preferably 5 to 300 mg/m² when expressed in terms of the coating amount per square meter of the light-sensitive material.

In this embodiment, the matting agent may be shaped either in a definite form or in an indefinite form. However, it is preferably shaped in a definite form, and the spherical form is preferably employed. The average particle diameter is in the range of preferably 0.5 to 10 μm, more preferably 1.0 to 8.0 μm, and furthermore preferably 2.0 to 6.0 μm. Whereas, the variation coefficient of the size distribution is preferably 50% or less, more preferably 40% or less, and furthermore preferably 30% or less. Herein, the variation coefficient denotes the value expressed as: (Standard deviation of particle diameter)/(average value of particle diameter)×100. Further, it is also preferable to use two kinds of matting agents each having a small variation coefficient, and an average particle diameter ratio of more than 3 in combination.

Further, any matting degree of the emulsion surface is acceptable so long as stardust defects will not occur. However, Bekk smoothness is preferably 30 seconds or more and 2000 seconds or less, and in particular preferably 40 seconds or more and 1500 seconds or less. Bekk smoothness can be determined with ease by Japanese Industrial Standard (JIS) P8119, “Testing Method for Smoothness of Paper and Paperboard by Bekk Tester” and TAPPI Standard Method T479.

As the matting degree of the back layer in this embodiment, the Bekk smoothness is preferably 1200 seconds or less and 10 seconds or more, more preferably 800 seconds or less and 20 seconds or more, and furthermore preferably 500 seconds or less and 40 seconds or more.

In this embodiment, the matting agent is preferably contained in the outermost surface layer or a layer functioning as the outermost surface layer of the light-sensitive material, or in a layer near the outer surface thereof, or preferably contained in a layer serving as a so-called protective layer.

The back layer applicable to this embodiment is described in paragraph No. 0128 to 0130 of JP-A-11-65021.

The photothermographic material of this embodiment preferably has a film surface pH of 7.0 or less, and more preferably 6.6 or less, before heat development processing. The film surface pH has no particular restriction on the lower limit, but it is about 3. The pH is most preferably in the range of 4 to 6.2. For controlling the film surface pH, an organic acid such as a phthalic acid derivative or a nonvolatile acid such as sulfuric acid, and a volatile base such as ammonia are preferably used from the viewpoint of reducing the film surface pH. In particular, ammonia is preferred to achieve a low film surface pH, because it tends to volatilize, and therefore it can be removed before the coating step or heat development.

Whereas, the process in which a nonvolatile base such as sodium hydroxide, potassium hydroxide, or lithium hydroxide and ammonia are used in combination is also preferably employed. Incidentally, a method for measuring the film surface pH is described in paragraph No. 0123 of Japanese Patent Application No. 11-87297.

A hardening agent may also be used for respective layers such as the light-sensitive layer, the protective layer, and the back layer of this embodiment. Examples of the hardening agent are mentioned in each method described in THE THEORY OF THE PHOTOGRAPHIC PROCESS, FOURTH EDITION, written by T. H. James, (published by Macmillan Publishing Co., Inc., published in 1977), pp. 77-87. Other than chrome alum, 2,4-dichloro-6-hydroxy-s-triazine sodium salt, N,N-ethylenebis(vinylsulfonacetamide), and N,N-propylenebis(vinylsulfonacetamide), the polyvalent metal ions described on page 78 of the above article and the like, polyisocyanates described in U.S. Pat. No. 4,281,060 and JP-A-6-208193; epoxy compounds described in U.S. Pat. No. 4,791,042; vinylsulfone type compounds described in JP-A-62-89048 and the like may preferably be used.

The hardening agent is added in the form of a solution. The timing of adding the solution into a protective layer coating solution is from 180 minutes before to immediately before coating, and preferably from 60 minutes before to 10 seconds before coating. However, there is no particular restriction as to the mixing process and the mixing conditions so long as the effects of this embodiment satisfactorily occur. As a specific mixing process, there are a method in which the mixing is performed in a tank configured such that the mean residence time therein calculated from the addition flow rate and the feeding amount to a coater becomes a desirable time; and a method using a static mixer described in Chapter 8 of Ekitai Kongo Gijutsu written by N. Harnby, M. F. Edwards, and A. W. Nienow, translated by Koji Takahashi, (published by Nikkan Kogyo Shinbunsha, 1989), and the like.

The surfactant applicable to this embodiment is described in paragraph No. 0132 of JP-A-11-65021; the solvent, in paragraph No. 0133, ibid.; the support, in paragraph No. 0134, ibid.; the antistatic or conductive layer, in paragraph No. 0135, ibid.; a method for obtaining color images, in paragraph No. 0136, ibid.; and the slipping agent, in paragraph Nos. 0061 to 0064 of JP-A-11-84573, and paragraph Nos. 0049 to 0062 of Japanese Patent Application No. 11-106881.

In this embodiment, the photothermographic material preferably has a conductive layer containing a metal oxide. As the conductive material of the conductive layer, a metal oxide increased in conductivity by introducing an oxygen defect or a different kind of metal atoms in the metal oxide is preferably used. Preferred examples of the metal oxide include ZnO, TiO₂, and SnO₂. Addition of Al or In to ZnO2, Sb, Nb, P, a halogen element, or the like to SnO₂, Nb, Ta, or the like to TiO₂ are preferred. In particular, SnO₂ incorporated with Sb is preferred. The amount of a different kind of atoms is preferably in the range of 0.01 to 30 mol %, and more preferably in the range of 0.1 to 10 mol %. The metal oxide may be shaped in any of the forms of sphere, needle, and tablet. However, a needle-shaped particles each having a ratio of the major axis/the minor axis of 2.0 or more, and preferably 3.0 to 50 are desirable in terms of the effect of imparting the conductivity. The amount of the metal oxide to be added is preferably in the range of 1 mg/m² to 1000 mg/m², more preferably in the range of 10 mg/m² to 500 mg/m², and furthermore preferably in the range of 20 mg/m² to 200 mg/m². The conductive layer of this embodiment may be disposed on any of the emulsion surface side and the back surface side. However, it is preferably disposed between the support and the back layer. The specific examples of the conductive layer of this embodiment are described in JP-A-7-295146 and JP-A-11-223901.

In this embodiment, a fluorine-containing surfactant is preferably used. Specific examples of the fluorine-containing surfactant may include the compounds described in JP-A-10-197985, JP-A-2000-19680, and JP-A-2000-214554. Further, the polymer fluorine-containing surfactants described in JP-A-9-281636 is also preferably used. For the photothermographic material of this embodiment, the fluorine-containing surfactants described in Japanese Patent Application Nos. 2000-206560, 2001-203642, 2001-242357, and 2001-264110 are preferably used. In particular, the fluorine-containing surfactants described in Japanese Patent Application Nos. 2001-242357 and No. 2001-264110 are preferred in terms of the charging control ability, the stability of the coated surface conditions, and the slipping property when coated in the form of an aqueous coating solution for production. The fluorine-containing surfactants described in Japanese Patent Application No. 2001-264110 are most preferred in terms of its high charging control ability and small required amount.

In this embodiment, the fluorine-containing surfactant can be used on either side of the emulsion surface and the back surface, and preferably used on both the surface sides. Further, it is in particular preferably used in combination with the foregoing conductive layer containing the metal oxide. In this case, even when the amount of the fluorine-containing surfactant to be used for the side having the conductive layer is reduced or nulled, it is possible to obtain satisfactory performances.

The fluorine-containing surfactant is used in an amount preferably in the range of 0.1 mg/m² to 100 mg/m², more preferably in the range of 0.3 mg/m² to 30 mg/m², and furthermore preferably in the range of 1 mg/m² to 10 mg/m², respectively for the emulsion surface and the back surface. In particular, the fluorine-containing surfactants described in Japanese Patent Application No. 2001-264110 produce large effects, so that each of them is used in an amount of preferably in the range of 0.01 mg/m² to 10 mg/m², and more preferably in the range of 0.1 mg/m² to 5 mg/m².

For a transparent support, polyester, in particular, polyethylene terephthalate, subjected to a heat treatment at a temperature in the range of 130 to 185° C. is preferably used in order to relax the internal distortion remaining in the film during the biaxial stretching, and thereby to eliminate the thermal shrinkage distortion occurring during the heat development processing. As for the photothermographic material for medical use, the transparent support may be colored by a blue dye (e.g., Dye-1 described in Example of JP-A-8-240877), or may be colorless. To the support, the undercoating techniques of the water-soluble polyester of JP-A-11-84574, the styrene-butadiene copolymer of JP-A-10-186565, the vinylidene chloride copolymer of JP-A-2000-39684 and paragraph Nos. 0063 to 0080 of Japanese Patent Application No. 11-106881, and the like are preferably applied. Whereas, to the antistatic layer or undercoating, the techniques described in JP-A-56-143430, JP-A-56-143431, JP-A-58-62646, JP-A-56-120519, paragraph Nos. 0040 to 0051 of JP-A-11-84573, U.S. Pat. No. 5,575,957, and paragraph Nos. 0078 to 0084 of JP-A-11-223898 can be applied.

The photothermographic material is preferably of a mono-sheet type (the type capable of forming images on the photothermographic material without using other sheets such as image-receiving materials).

To the photothermographic material, further, an antioxidant, a stabilizer, a plasticizer, a UV absorber, or a coating aid may also be added. Various additives are added to any of light-sensitive layers or non-light-sensitive layers. With regard to these, WO 98/36322, EP 803764A1, JP-A-10-186567, JP-A-10-18568, and the like can serve as references.

The photothermographic material in this embodiment may be coated by any method. Specifically, various coating operations including: extrusion coating, slide coating, curtain coating, dip coating, knife coating, flow coating, and extrusion coating using a hopper of the type described in U.S. Pat. No. 2,681,294 are used. Extrusion coating or slide coating described in LIQUID FILM COATING, written by Stephen F. Kistler, and Petert M. Schweizer, (published by CHAPMAN & HALL Co., Ltd., 1997), pp. 399 to 536 are preferably used. In particular, slide coating is preferably used. An example of the shape of a slide coater for use in the slide coating is shown in FIG. 11b. 1, on page 427 of the same reference. Whereas, if desired, two layers or more layers may be formed at the same time with the method described from page 399 to page 536 of the same reference, and the methods described in U.S. Pat. No. 2,761,791 and GB No. 837,095.

The organic silver salt-containing layer coating solution in this embodiment is preferably a so-called thixotropy fluid. With regard to this technique, JP-A-11-52509 can serve as a reference. The organic silver salt-containing layer coating solution in this embodiment has a viscosity at a shear rate of 0.1 s-1 of preferably 400 mPa.s or more and 100,000 mPa.s or less, and more preferably 500 mPa.s or more and 20,000 mPa.s or less. Whereas, at a shear rate of 1000 s⁻¹, the viscosity is preferably 1 mPa.s or more and 200 mPa.s or less, and more preferably 5 mPa.s or more and 80 mPa.s or less.

As the techniques usable for the photothermographic material of this embodiment, mention may also be made of: EP803764A1, EP883022A1, WO98/36322, JP-A-56-62648, JP-A-58-62644, JP-A-9-43766, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, JP-A-10-186569 to JP-A-10-186572, JP-A-10-197974, JP-A-10-197982, JP-A-10-197983, JP-A-10-197985 to JP-A-10-197987, JP-A-10-207001, JP-A-10-207004, JP-A-10-221807, JP-A-10-282601, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574, JP-A-11-65021, JP-A-11-109547, JP-A-11-125880, JP-A-11-129629, JP-A-11-133536 to JP-A-11-133539, JP-A-11-133542, JP-A-11-133543, JP-A-11-223898, JP-A-11-352627, JP-A-11-305377, JP-A-11-305378, JP-A-11-305384, JP-A-11-35380, JP-A-11-316435, JP-A-11-327076, JP-A-11-338096, JP-A-11-358098, JP-A-11-338099, JP-A-11-343420, Japanese Patent Application Nos. 2000-187298, 2000-10229, 2000-47345, 2000-206642, 2000-98530, 2000-98531, 2000-112059, 2000-112060, 2000-112104, 2000-112064, and 2000-171936.

(Explanation of Packaging Material)

The light-sensitive material of this embodiment is preferably packaged in a packaging material with a low oxygen permeability and/or moisture permeability in order to suppress the fluctuations in photographic performances during raw storage, or in order to improve curling or rolling habit. The oxygen permeability is preferably 50 ml/atm.m²day or less, more preferably 10 ml/atm.m²day or less, and furthermore preferably 1.0 ml/atm.m².day or less at 25° C. The moisture permeability is preferably 10 g/atm.m².day or less, more preferably 5 g/atm.m².day or less, and furthermore preferably 1 g/atm.m².day or less.

Specific examples of the packaging material with a low oxygen permeability and/or moisture permeability are the packaging materials described in, for example, JP-A-8-254793 and JP-A-2000-206653.

(Explanation of Heat Development)

The photothermographic material of this embodiment may be developed in any manner. However, in general, the imagewise exposed photothermographic material is developed by heating. The preferred development temperature is 80 to 250° C., preferably 100 to 140° C., and further preferably 110 to 130° C. The development time is preferably 1 to 60 seconds, more preferably 3 to 30 seconds, furthermore preferably 5 to 25 seconds, and in particular preferably 7 to 15 seconds.

As a system for heat development, any of a drum type heater and a plate type heater may be used. However, the plate heater system is more preferred. For a heat development system by the plate heater system, the method described in JP-A-11-133572 is preferred. The system is a heat development apparatus whereby a photothermographic material on which a latent image has been formed is brought into contact with a heating means in a heat development unit to obtain a visible image. The heat development apparatus is characterized in that the heating means comprises a plate heater, a plurality of pressing rollers are disposed along one surface of the plate heater and in positions opposite thereto, and that the heat development is performed by allowing the photothemographic material to pass between the pressing rollers and the plate heater. Preferably, the plate heater is sectioned into 2 to 6 stages, and the tip is reduced in temperature by about 1 to 10° C. For example, mention may be made of the example in which 4 sets of plate heaters capable of independent temperature control are used, and the respective heaters are controlled so as to be at 112° C., 119° C., 121° C., and 120° C. Such a method is also described in JP-A-54-30032. This can remove the moisture and the organic solvent contained in the photothermographic material out of the system, and can suppress the change in shape of the support of the photothermographic material caused by rapidly heating the photothermographic material.

Although the light-sensitive material of this embodiment may be exposed to light by any method, a laser light is preferably used for a light source for exposure. For the laser light according to this embodiment, a gas laser (Ar⁺ or He—Ne), a YAG laser, a dye laser, a semiconductor laser, or the like is preferred. Further, a semiconductor laser, and a second harmonics-generating element or the like can also be used. A gas or semiconductor laser for red to infra red light emission is preferred.

As a laser imager having an exposure part and a heat development part for the medical use, Fuji Medical Dry Laser Imager FM-DP L can be mentioned. FM-DP L are described in Fuji Medical Review No. 8, pp. 39 to 55. It is needless to say that these techniques are applicable to the laser imager for the photothermographic material of this embodiment. Whereas, these techniques are also applicable as the photothermographic materials for the laser imager in “AD network” proposed by Fuji Medical System as a network system adapted to the DICOM Standards.

The photothermographic material of this embodiment forms a black and white image based on a silver image. It is preferably used as a photothermographic material for the medical diagnosis, as a photothermographic material for the industrial photography, as a photothermographic material for the printing use, and as a photothermographic material for the COM use.

### [EXAMPLES]

Below, a specific description will be given by way of examples, which should not be construed as liming this embodiment.

### EXAMPLE 1

(Preparation of PET Support)

PET having an intrinsic viscosity IV=0.66 (measured at 25° C. in phenol/tetrachloroethane=6/4 (weight ratio)) was obtained according to an ordinary method by using terephthalic acid and ethylene glycol. This was pelletized, and then dried at 130° C. for 4 hours, followed by melting at 300° C. Then, the molten PET was extruded through a T-die, and cooled rapidly to prepare an unstreched film having such a thickness as to provide a film thickness after heat fixing of 1751 m.

Using rolls different in circumferential speed, this was longitudinally stretched to 3.3 times, and then laterally stretched to 4.5 times by means of a tenter. The temperatures at this step were 110° C. and 130° C., respectively. Thereafter, the stretched film was thermally fixed at 240° C. for 20 seconds, and then subjected to relaxation in the lateral direction by 4% at the same temperature. Then, after slitting the chuck portion of the tenter, the opposite ends were subjected to knurl processing, and the film was wound at 4 kg/cm² to obtain a 175 μm-thick rolled support.

(Surface Corona Treatment)

Using a 6-KVA model of solid state corona treatment apparatus manufactured by Pillar Corporation, the opposite surfaces of the support were treated at 20 m/minute under room temperature. From the read values of current and voltage at this step, it was confirmed that the support was treated at 0.375 kV.A.minute/m². The treatment frequency at this step was 9.6 kHz, and the gap clearance between the electrode and a dielectric roll was 1.6 mm.

(Preparation of Undercoated Support)

(1) Preparation of undercoat layer coating solution

Formulation (1) (for undercoat layer on the light-sensitive layer side)

| | | |
|---|---|---|
| PESRESIN A-520 (30 mass % solution) | 59 | g |
| manufactured by Takamatsu Oil & Fat Co., Ltd., | | |
| Polyethylene glycol monononylphenyl ether | 5.4 | g |
| (average ethylene oxide number = 8.5) 10 mass % solution | | |
| MP- 1000 | 0.91 | g |
| (polymer fine particles, average particle diameter = 0.4 μm), | | |
| manufactured by Soken Chemical & Engineering Co., Ltd.) | | |
| Distilled water | 935 | ml |
| Formulation (2) (for a first layer on the back surface side) | | |
| Styrene-butadiene copolymer latex | 158 | g |
| (solid content: 40 mass %, styrene/butadiene weight | | |
| ratio = 68/32) | | |
| 2,4-Dichloro-6-hydroxy-S-triazine sodium salt | 20 | g |
| 8 mass % aqueous solution | | |
| 1 mass % aqueous solution of sodium laurylbenzenesulfonate | 10 | ml |
| Distilled water | 854 | ml |
| Formulation (2) (for a second layer on the back surface side) | | |
| SnO₂/SbO | 84 | g |
| (9/1 mass ratio, average particle diameter: 0.038 μm, | | |
| 17 mass % dispersion) | | |
| Gelatin (10 mass % aqueous solution) | 89.2 | g |
| METOLOSE TC-5 (2 mass % aqueous solution) | 8.6 | g |
| manufactured by Shin-Etsu Chemical Co., Ltd. | | |
| MP- 1000 | 0.01 | g |
| manufactured by Soken Chemical & Engineering Co., Ltd.) | | |
| 1 mass % aqueous solution of sodium | 10 | ml |
| dodecylbenzenesulfonate | | |
| NaOH (1 mass %) | 6 | ml |
| Proxel (manufactured by ICI Co.) | 1 | ml |
| Distilled water | 805 | ml |

Both surfaces of the 175 μm-thick biaxially stretched polyethylene terephthalate support were respectively subjected to the corona discharge treatment. Then, one surface (light-sensitive layer side) thereof was coated with the undercoating solution formulation (1) by a wire bar in a wet coating amount of 6.6 ml/m² (per side), and dried at 180° C. for 5 minutes. Then, the back surface (back side) thereof was coated with the undercoating solution formulation (2) by a wire bar in a wet coating amount of 5.7 ml/m², and dried at 180° C. for 5 minutes. The back surface (back side) was further coated with the undercoating solution formulation (3) by a wire bar in a wet coating amount of 7.7 ml/m², and dried at 180° C. for 6 minutes to prepare an undercoated support.

(Preparation of Back Surface Coating Solution)

(Preparation of Solid Fine Particle Dispersion (a) of Base Precursor)

1.5 kg of Base precursor compound 1, 225 g of a surfactant (trade name: Demol N, manufactured by Kao Corp., Ltd.), 937.5 g of diphenylsulfone, 15 g of parahydroxybenzoic acid butyl ester (trade name MEKKINS: manufactured by UENO Fine Chemicals Industry, Ltd.), and distilled water in an amount such that the total amount became 5.0 kg were mixed. The resulting mixed solution was subjected to beads dispersion using a sand mill of horizontal type (UVM-2: manufactured by Imex Co., Ltd.). The dispersion was accomplished in the following manner. The mixed solution was fed through a diaphragm pump to UVM-2 filled with zirconia beads with an average particle diameter of 0.5 mm, and dispersed with an internal pressure at 50 hPa or more until a desirable average particle diameter was obtained.

The dispersion was dispersed to the point where upon performing the spectral absorption measurement, the ratio of absorbance at 450 nm to absorbance at 650 nm (D450/D650) in the spectral absorption of the dispersion was 2.2 or more. The dispersion thus obtained was diluted with distilled water so as to be in a concentration of 20 mass % in terms of the concentration of the base precursor. The diluted dispersion was filtrated (through a polypropylene filter with an average pore diameter: 3 μm) for removing dust, and subjected to practical use.

(Preparation of Dye Solid Fine particle Dispersion)

6.0 kg of Cyanine dye compound-1, 3.0 kg of sodium p-dodecylbenzenesulfonate, and 0.6 kg of a surfactant, Demol SNB manufactured by Kao Corp., Ltd., and 0.15 kg of an antifoaming agent (trade name: Surfynol 104 E, manufactured by Nissin Chemical Industry, Co., Ltd.) were mixed with distilled water, thereby to make the total solution amount 60 kg. The mixed solution was dispersed by 0.5-mm zirconia beads by means of a sand mill of horizontal type (UVM-2: manufactured by Imex Co., Ltd.).

The dispersion was dispersed to the point where upon performing the spectral absorption measurement, the ratio of absorbance at 650 nm to absorbance at 750 nm (D650/D750) in the spectral absorption of the dispersion was 5.0 or more. The dispersion thus obtained was diluted with distilled water so as to be in a concentration of 6 mass % in terms of the concentration of Cyanine dye. The diluted dispersion was filtrated through a filter (average pore diameter: 1 μm) for removing dust, and subjected to practical use.

(Preparation of Antihalation Layer Coating Solution)

30 g of gelatin, 24.5 g of polyacrylamide, 2.2 g of 1 mol/l caustic soda, 2.4 g of monodispersed polymethyl methacrylate fine particles (average particle size 8 μm, particle diameter standard deviation 0.4), 0.08 g of benzisothiazolinone, 35.9 g of the dye solid fine particle dispersion, 74.2 g of the base precursor solid fine particle dispersion (a), 0.6 g of sodium polyethylene sulfonate, 0.21 g of Blue dye compound-1, 0.15 g of Yellow dye compound-1, and 8.3 g of an acrylic acid/ethyl acrylate copolymer latex (copolymerization ratio 5/95) were mixed. Water was added thereto to make the total volume 818 ml, thereby to prepare an antihalation layer coating solution.

(Preparation of Back-side Protective Layer Coating Solution)

In a vessel kept at 40° C., 40 g of gelatin, a liquid paraffin emulsion in an amount of 1.5 g in terms of liquid paraffin, 35 mg of benzisothiazolinone, 6.8 g of caustic soda with a concentration of 1 mol/L, 0.5 g of sodium t-octylphenoxyethoxyethanesulfonate, 0.27 g of sodium polystyrenesulfonate, 5.4 mg of a 2% aqueous solution of Fluorine-containing surfactant (F-1), 5.4 mg of a 2% aqueous solution of Fluorine-containing surfactant (F-2), 6.0 g of an acrylic acid/ethyl acrylate copolymer (copolymerization weight ratio: 5/95), and 2.0 g of N,N-ethylenebis(vinyl sulfonamide) were mixed. The resulting mixture was diluted to 1000 ml with water, resulting in a back-side protective layer coating solution.

(Preparation of Silver Halide Emulsion)<

<Preparation of Silver Halide Emulsion 1>>

To 1421 ml of distilled water, 3.1 ml of a 1 mass % potassium bromide solution was added, and further, 3.5 ml of sulfuric acid with a concentration of 0.5 mol/L and 31.7 g of phthalated gelatin were added. The resulting solution was kept at a temperature of 30° C. with stirring in a reaction jar made of stainless steel. Solution A was prepared by diluting 22.22 g of silver nitrate with the addition of distilled water to 95.4 ml, and Solution B was prepared by diluting 15.3 g of potassium bromide and 0.8 g of potassium iodide with the addition of distilled water to a volume of 97.4 ml. The whole amount of Solutions A and B were added thereto at a constant flow rate over 45 seconds. Then, 10 ml of a 3.5 mass % hydrogen peroxide aqueous solution was added thereto, and further, 10.8 ml of a 10 mass % aqueous solution of benzimidazole was added thereto. Further, Solution C was prepared by diluting 51.86 g of silver nitrate with the addition of distilled water to 317.5 ml, and Solution D was prepared by diluting 44.2 g of potassium bromide and 2.2 g of potassium iodide to a volume of 400 ml with distilled water. The whole amount of Solution C was added at a given flow rate over 20 minutes. Whereas, Solution D was added while keeping the pAg at 8.1 with a controlled double jet method. Potassium hexachloroiridate (III) was added in an amount of 1×10⁻⁴ mol per mole of silver all at once after 10 minutes from the start of addition of Solutions C and D. Whereas, an aqueous solution of potassium iron (II) hexacyanide was added in an amount of 3×10⁻⁴ mol per mole of silver all at once after 5 seconds from the completion of addition of Solution C. The pH was adjusted to 3.8 using sulfuric acid with a concentration of 0.5 mol/L, and stirring was stopped. Then, steps of sedimentation/desalting/washing with water were carried out. The resulting mixture was adjusted to pH 5.9 with sodium hydroxide with a concentration of 1 mol/L. Thus, a silver halide dispersion with a pAg 8.0 was prepared.

The silver halide dispersion was kept at 38° C. with stirring, to which was added 5 ml of a 0.34 mass % methanol solution of 1,2-benzisothiazolin-3-one. After 40 minutes, a methanol solution of Spectral sensitizing dye A and Spectral sensitizing dye B in a molar ratio of 1:1 was added thereto in a total amount of Sensitizing dyes A and B of 1.2×10⁻³ mol per mole of silver. The mixture was heated to 47° C. after 1 minute. After 20 minutes from the heating, sodium benzenethiosulfonate was added in an amount of 7.6×10-5 mol per mole of silver in the form of methanol solution. Further, after 5 minutes, Tellurium sensitizer C was added thereto in an amount of 2.9×10⁻⁴ mol per mole of silver in the form of methanol solution, followed by aging for 91 minutes. Then, 1.3 ml of a 0.8 mass % methanol solution of N,N′-dihydroxy-N′-diethylmelamine was added thereto, and after another 4 minutes, thereto were added 5-methyl-2-mercaptobenzimidazole in the form of methanol solution in an amount of 4.8×10⁻³ mol per mole of silver, and 1-phenyl-2-heptyl-5-mercapto-1,3,4-triazole in the form of methanol solution in an amount of 5.4×10⁻³ mol per mole of silver. As a result, Silver halide emulsion 1 was prepared.

The grains in the prepared silver halide emulsion were silver iodobromide grains uniformly containing iodine in an amount of 3.5 mol %, and having a mean sphere equivalent diameter of 0.042 μm, and a variation coefficient of sphere equivalent diameter of 20%. The grain size and the like were determined from the average of 1000 grains by using an electron microscope. The [100] plane proportion of these grains was determined to be 80% by using the Kubelka-Munk method.

<<Preparation of Silver halide Emulsion 2>>

Silver halide emulsion 2 was prepared in the same manner as in preparation of Silver halide emulsion 1, except that the solution temperature of 30° C. during grain formation was changed to 47° C., that Solution B was prepared by diluting 15.9 g of potassium bromide to a volume of 97.4 ml with distilled water, that Solution D was prepared by diluting 45.8 g of potassium bromide to a volume of 400 ml with distilled water, that the length of time over which Solution C was added was changed to 30 minutes, and that the potassium iron (II) hexacyanide was removed. The sedimentation/desalting/washing with water/dispersion were carried out as with Silver halide emulsion 1. Further, Silver halide emulsion 2 was obtained by performing spectral sensitization, chemical sensitization, and addition of 5-methyl-2-mercaptobenzimidazole and 1-phenyl-2-heptyl-5-mercapto-1,3,4-triazole in the same manner as with Emulsion 1, except for the following changes: the amount of the methanol solution of Spectral sensitizing dye A and Spectral sensitizing dye B in a molar ratio of 1:1 to be added was changed to 7.5×10⁻⁴ mol in terms of the total amount of Sensitizing dyes A and B of per mole of silver; the amount of Tellurium sensitizer C to be added was changed to 1.1×10⁻⁴ mol per mole of silver; and the amount of 1-phenyl-2-heptyl-5-mercapto-1,3,4-triazole was changed to 3.3×10⁻³ mol per mole of silver. The emulsion grains of Silver halide emulsion 2 were pure silver bromide cubic grains with a mean sphere equivalent diameter of 0.080 μm and a variation coefficient of sphere equivalent diameter of 20%.

<<Preparation of Silver Halide Emulsion 3>>

Silver halide emulsion 3 was prepared in the same manner as in preparation of Silver halide emulsion 1, except that the solution temperature of 30° C. during grain formation was changed to 27° C. Further, the sedimentation/desalting/washing with water/dispersion were carried out as with Silver halide emulsion 1. Further, Silver halide emulsion 3 was obtained in the same manner as with Emulsion 1, except that Spectral sensitizing dye A and Spectral sensitizing dye B were added in a molar ratio of 1:1 in the form of a solid dispersion (gelatin aqueous solution) in a total amount of Sensitizing dyes A and B of 6×10⁻³ mol per mole of silver, that the amount of Tellurium sensitizer C to be added was changed to 5.2×10⁻⁴ mol per mole of silver, and that after 3 minutes from the addition of the Tellurium sensitizer, auric bromide in an amount of 5×10⁻⁴ mol per mole of silver, and potassium thiocyanate in an amount of 2×10⁻³ mol per mole of silver were added. The emulsion grains of Silver halide emulsion 3 were silver iodobromide grains uniformly containing iodine in an amount of 3.5 mol %, and having a mean sphere equivalent diameter of 0.034 μm, and a variation coefficient of sphere equivalent diameter of 20%.

<<Preparation of Mixed Emulsion A for Coating Solution>>

Silver halide emulsion 1 in an amount of 70 mass %, Silver halide emulsion 2 in an amount of 15 mass %, and Silver halide emulsion 3 in an amount of 15 mass % were mixed and dissolved together. Thereto, benzothiazolium iodide was added in the form of a 1 mass % aqueous solution in amount of 7×10⁻³ mol per mole of silver. Further, water was added so that the silver halide content per kilogram of the mixed emulsion for coating solution calculated in terms of silver was 38.2 g.

<<Preparation of Fatty acid silver dispersion A>>

87.6 kg of behenic acid (trade name: Edenor C22-85R) manufactured by Henckel Co., 423 L of distilled water, 49.2 L of an aqueous solution of NaOH with a concentration of 5 mol/L and 120 L of t-butyl alcohol were mixed, and stirred at 75° C. for 1 hour to effect the reaction, thereby obtaining Sodium behenate solution A. Separately, 206.2 L of an aqueous solution of 40.4 kg of silver nitrate (pH 4.0) was prepared, and kept at a temperature of 10° C. A reaction vessel containing 635 L of distilled water and 30 L of t-butyl alcohol therein was kept at a temperature of 30° C., and the whole amount of Sodium behenate solution A previously prepared and the whole amount of the aqueous solution of silver nitrate were added with sufficient stirring thereto at a constant flow rate over 93 minutes and 15 seconds and over 90 minutes, respectively. This step was carried out in the following manner. Only the aqueous solution of silver nitrate was added for 11 minutes after the start of addition of the aqueous solution of silver nitrate. Thereafter, addition of Sodium behenate solution A was started, and only Sodium behenate solution A was added for 14 minute and 15 seconds after completion of addition of the aqueous solution of silver nitrate. At this step, the temperature in the reaction vessel was set at 30° C., and the temperature of the outside was controlled so that the liquid temperature was maintained constant. Further, the piping of the addition system for Sodium behenate solution A was heat-insulated by circulating warm water outside the double pipe, and adjusted so that the liquid temperature at the outlet of the tip of the addition nozzle became 75° C. Whereas, the piping of the addition system of the aqueous solution for silver nitrate was heat-insulated by circulating cool water outside the double pipe. The position of adding Sodium behenate solution A and the position of adding the aqueous solution of silver nitrate were arranged symmetrically with respect to the stirring shaft as the center, and also adjusted at such a height as not to cause contact with the reaction solution.

After completion of the addition of Sodium behenate solution A, the mixture was allowed to stand with stirring for 20 minutes with the temperature unchanged, and heated to 35° C. over 30 minutes, followed by aging for 210 minutes. Immediately after completion of aging, the solid content was separated by centrifugal filtration, and then, the solid content was washed with water until the conductivity of the filtrate water became 30 μS/cm. A fatty acid silver salt was obtained in this manner. The obtained solid content was not dried, and stored in the form of a wet cake.

The shapes of the obtained silver behenate grains were evaluated by an electron microscopic photography, so that the grains were found to be scaly crystals having a=0.14 μm, b=0.14 μm, and c=0.6 μm, in average values, an average aspect ratio of 5.2, a mean sphere equivalent diameter of 0.52 μm, and a variation coefficient of sphere equivalent diameter of 15% (a, b, and c are defined in this specification).

To the wet cake corresponding to 260 kg of the dry solid content, 19.3 Kg of polyvinyl alcohol (trade name: PVA-217) and water were added to make the total amount 1000 Kg. Then, the resulting mixture was made into a slurry by means of a dissolver blade, and further pre-dispersed by means of a pipeline mixer (PM-10 model: manufactured by MIZUHO Industrial Co., Ltd.).

Then, the pre-dispersed stock dispersion was treated three times by means of a dispersing machine (trade name: Microfluidizer-M-610, manufactured by Microfluidex International Corporation, using Z model interaction chamber) with the pressure controlled to be 1260 kg/cm² to obtain a silver behenate dispersion. During the cooling operation, the dispersion temperature was set at 18° C. by providing coiled heat exchangers fixed before and after the interaction chamber, and controlling the temperature of the refrigerant.

<<Preparation of Fatty acid silver Dispersion B>>

<Preparation of Recrystallized Behenic Acid>

100 Kg of behenic acid (trade name: Edenor C22-85R) manufactured by Henckel Co., was mixed with 1200 Kg of isopropyl alcohol, and dissolved at 50° C. The resulting mixture was filtrated through a 10-μm filter, and then cooled to 30° C. to perform recrystallization. The cooling speed for performing recrystallization was controlled to 3° C./hour. The obtained crystals were subjected to centrifugal filtration, and applied and washed with 100 Kg of isopropyl alcohol, followed by drying. The obtained crystals were subjected to esterification and a GC-FID measurement. This indicated that the silver behenate content was 96%, and that, other than this, lignoceric acid in an amount of 2% and arachidic acid in an amount of 2% were contained therein.

<<Preparation of Fatty Acid Silver Salt Dispersion B>>

88 Kg of recrystallized behenic acid, 422 L of distilled water, 49.2 L of an aqueous solution of NaOH with a concentration of 5 mol/L, and 120 L of t-butyl alcohol were mixed, and stirred at 75° C. for 1 hour to effect the reaction, thereby obtaining Sodium behenate solution B. Separately, 206.2 L of an aqueous solution of 40.4 kg of silver nitrate (pH 4.0) was prepared, and kept at a temperature of 10° C. A reaction vessel containing 635 L of distilled water and 30 L of t-butyl alcohol therein was kept at a temperature of 30° C., and the whole amount of Sodium behenate solution B previously prepared and the whole amount of the aqueous solution of silver nitrate were added with sufficient stirring thereto at a constant flow rate over 93 minutes and 15 seconds and over 90 minutes, respectively. This step was carried out in the following manner. Only the aqueous solution of silver nitrate was added for 11 minutes after the start of addition of the aqueous solution of silver nitrate. Thereafter, addition of Sodium behenate solution B was started, and only Sodium behenate solution B was added for 14 minute and 15 seconds after completion of the addition of the aqueous solution of silver nitrate. At this step, the temperature in the reaction vessel was set at 30° C., and the temperature of the outside was controlled so that the liquid temperature was maintained constant. Further, the piping of the addition system for Sodium behenate solution B was heat-insulated by circulating warm water outside the double pipe, and adjusted so that the liquid temperature at the outlet of the tip of the addition nozzle became 75° C. Whereas, the piping of the addition system for the aqueous solution of silver nitrate was heat-insulated by circulating cool water outside the double pipe. The position of adding Sodium behenate solution B and the position of adding the aqueous solution of silver nitrate were arranged symmetrically with respect to the stirring shaft as the center, and adjusted at such a height as not to cause contact with the reaction solution.

After completion of the addition of Sodium behenate solution B, the mixture was allowed to stand with stirring for 20 minutes with the temperature unchanged, and heated to 35° C. over 30 minutes, followed by aging for 210 minutes. Immediately after completion of aging, the solid content was separated by centrifugal filtration, and then, the solid content was washed with water until the conductivity of the filtrate water became 30 μS/cm. A fatty acid silver salt was obtained in this manner. The obtained solid content was not dried, and stored in the form of a wet cake.

The shapes of the obtained silver behenate grains were evaluated by an electron microscopic photography, so that the grains were found to be crystals having a =0.21 μm, b=0.4 μm, and c=0.4 μm, in average values, an average aspect ratio of 2.1, a mean sphere equivalent diameter of 0.51 μm, and a variation coefficient of sphere equivalent diameter of 11% (a, b, and c are defined in this specification).

To the wet cake corresponding to 260 kg of the dry solid content, 19.3 Kg of polyvinyl alcohol (trade name: PVA-217) and water were added to make the total amount 1000 Kg. Then, the resulting mixture was made into a slurry by means of a dissolver blade, and further pre-dispersed by means of a pipeline mixer (PM-10 model: manufactured by MIZUHO Industrial Co., Ltd.).

Then, the pre-dispersed stock dispersion was treated three times by means of a dispersing machine (trade name: Microfluidizer-M-610, manufactured by Microfluidex International Corporation, using Z model interaction chamber) with the pressure controlled to be 1150 kg/cm² to obtain a silver behenate dispersion. During the cooling operation, the dispersion temperature was set at 18° C. by providing coiled heat exchangers fixed before and after the interaction chamber, and controlling the temperature of the refrigerant.

(Preparation of Reducing Agent Dispersion)<

<Preparation of Reducing Agent Complex-1 Dispersion>>

To 10 Kg of Reducing agent complex-1 (1:1 complex of 6,6′-di-t-butyl-4,4′-dimethyl-2, 2′-butylidene diphenol and triphenylphosphine oxide), 0.12 Kg of triphenylphosphine oxide, and 16 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 4 hours and 30 minutes. Then, 0.2 g of benzothiazolinone sodium salt and water were added thereto, so that the concentration of the reducing agent complex was adjusted to 20 mass %. Thus, Reducing agent complex-1 dispersion was obtained. The reducing agent complex grains contained in the reducing agent complex dispersion thus obtained had a median diameter of 0.45 μm and a maximum grain diameter of 1.4 μm or less. The reducing agent complex dispersion obtained was filtered through a filter made of polypropylene having a pore size of 3.0 μm to remove foreign matters such as dusts, and stored.

<<Preparation of Reducing Agent-2 Dispersion>>

To 10 Kg of Reducing agent-2 (6,6′-di-t-butyl-4,4′-dimethyl-2,2′-butylidene diphenol), and 16 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzothiazolinone sodium salt and water were added thereto, so that the concentration of the reducing agent was adjusted to 20 mass %. The dispersion was heat treated at 60° C. for 5 hours to obtain Reducing agent-2 dispersion. The reducing agent grains contained in the reducing agent dispersion thus obtained had a median diameter of 0.40 μm and a maximum grain diameter of 1.5 μm or less. The reducing agent dispersion obtained was filtered through a filter made of polypropylene having a pore size of 3.0 μm to remove foreign matters such as dusts, and stored.

<<Preparation of Hydrogen Bonding Compound-1 Dispersion>>

To 10 Kg of Hydrogen bonding compound-1 (tri(4-t-butylphenyl)phosphine oxide), and 16 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzothiazolinone sodium salt and water were added thereto, so that the concentration of the hydrogen bonding compound was adjusted to 25 mass %. The dispersion was warmed at 80° C. for 1 hour to obtain Hydrogen bonding compound-1 dispersion. The hydrogen bonding compound grains contained in the hydrogen bonding compound dispersion thus obtained had a median diameter of 0.35 μm and a maximum grain diameter of 1.5 μm or less. The hydrogen bonding compound dispersion obtained was filtered through a filter made of polypropylene having a pore size of 3.0 μm to remove foreign matters such as dusts, and stored.

<<Preparation of Development accelerator-1 dispersion>>

To 10 Kg of Development accelerator-1, and 20 Kg of a 10 mass % aqueous solution of modified polyvinyl alcohol (POVAL MP203 manufactured by Kuraray Co., Ltd.), 10 Kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzothiazolinone sodium salt and water were added thereto, so that the concentration of the development accelerator was adjusted to 20 mass %. Thus, Development accelerator-1 dispersion was obtained. The development accelerator grains contained in the development accelerator dispersion thus obtained had a median diameter of 0.48 μm and a maximum grain diameter of 1.4 μm or less. The development accelerator dispersion obtained was filtered through a filter made of polypropylene having a pore size of 3.0 μm to remove foreign matters such as dusts, and stored.

Also for each of the solid dispersions of Development accelerator-2 and Tone modifier-1, dispersion was carried out in the same manner as with Development accelerator-1 to obtain a 20 mass % dispersion.

(Preparation of Polyhalogen Compound)<

<Preparation of Organic Polyhalogen Compound-1 Dispersion>>

10 Kg of Organic polyhalogen compound-1 (tribromomethane sulfonylbenzene), 10 Kg of a 20 mass % aqueous solution of modified polyvinyl alcohol (POVAL MP203 manufactured by Kuraray Co., Ltd.), 0.4 Kg of a 20 mass % aqueous solution of sodium triisopropyl naphthalene sulfonate, and 14 Kg of water were added together, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 5 hours. Then, 0.2 g of benzothiazolinone sodium salt and water were added thereto, so that the concentration of the organic polyhalogen compound was adjusted to 26 mass %. Thus, Organic polyhalogen compound-1 dispersion was obtained. The organic polyhalogen compound grains contained in the organic polyhalogen compound dispersion thus obtained had a median diameter of 0.41 μm and a maximum grain diameter of 2.0 μm or less. The organic polyhalogen compound dispersion obtained was filtered through a filter made of polypropylene having a pore size of 10.0 μm to remove foreign matters such as dusts, and stored.

<<Preparation of Organic Polyhalogen Compound-2 Dispersion>>

10 Kg of Organic polyhalogen compound-2 (N-butyl-3-tribromomethane sulfonyl benzamide), 20 Kg of a 10 mass % aqueous solution of modified polyvinyl alcohol (POVAL MP203 manufactured by Kuraray Co., Ltd.), and 0.4 Kg of a 20 mass % aqueous solution of sodium triisopropyl naphthalene sulfonate, were added together, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 5 hours. Then, 0.2 g of benzothiazolinone sodium salt and water were added thereto, so that the concentration of the organic polyhalogen compound was adjusted to 30 mass %. The resulting despersion was warmed at 40° C. for 5 hours to obtain Organic polyhalogen compound-2 dispersion. The organic polyhalogen compound grains contained in the organic polyhalogen compound dispersion thus obtained had a median diameter of 0.40 μm and a maximum grain diameter of 1.3 μm or less. The organic polyhalogen compound dispersion obtained was filtered through a filter made of polypropylene having a pore size of 3.0 μm to remove foreign matters such as dusts, and stored.

<<Preparation of Phthalazine Compound-1 Solution>>

8 Kg of modified polyvinyl alcohol MP203 manufactured by Kuraray Co., Ltd., was dissolved in 174.57 Kg of water. Then, 3.15 Kg of a 20 mass % aqueous solution of sodium triisopropyl naphthalne sulfonate and 14.28 Kg of a 70 mass % aqueous solution of Phthalazine compound-1 (6-isopropyl phthalazine) were added thereto to prepare a 5 mass % solution of Phthalazine compound-1.

(Preparation of Mercapto Compound)<

<Preparation of Mercapto Compound-1 Aqueous Solution>>

7 g of Mercapto compound-1 (1-(3-sulfophenyl)-5-mercaptotetrazole sodium salt) was dissolved in 993 g of water, resulting in a 0.7 mass % aqueous solution.

<<Preparation of Mercapto Compound-2 Aqueous Solution>>

20 g of Mercapto compound-2 (1-(3-methylureide)-5-mercaptotetrazole sodium salt) was dissolved in 980 g of water, resulting in a 2.0 mass % aqueous solution.

<<Preparation of Pigment-1 Dispersion>>

To 64 g of C.I. Pigment Blue 60 and 6.4 g of Demol N manufactured by Kao Corp., Ltd., 250 g of water was added, and well mixed, resulting in a slurry. 800 g of zirconia beads with an average diameter of 0.5 mm were prepared, and injected together with the slurry in a vessel. Dispersion was carried out for 25 hours by means of a disperser (1/4 sandgrinder mill: manufacutred by Imex Co., Ltd.), to obtain Pigment-1 dispersion. The pigment grains contained in the pigment dispersion thus obtained had an average grain diameter of 0.21 μm.

<<Preparation of SBR latex>>

SBR latex whose Tg=22° C. was prepared in the following manner.

By using ammonium persulfate as a polymerization initiator, and an anionic surfactant as an emulsifier, 70.0 parts by mass of styrene, 27.0 parts by mass of butadiene, and 3.0 parts by mass of acrylic acid were emulsion-polymerized, followed by aging at 80° C. for 8 hours. Thereafter, the mixture was cooled to 40° C., and adjusted to pH 7.0 with aqueous ammonia. Further, SANDET BL manufactured by Sanyo Chemical Industries, Ltd., was added thereto in an amount of 0.22%. Then, a 5% aqueous sodium hydroxide solution was added thereto to pH 8.3, and the mixture was further adjusted to pH 8.4 with aqueous ammonia. The molar ratio of Na⁺ ions to NH⁴⁺ ions was 1:2.3. Further, to every one kilogram of this solution, 0.15 ml of a 7% aqueous solution of sodium benzisothiazolinone sodium salt was added to prepare a SBR latex solution. (SBR latex: latex of -St(70.0)-Bu(27.0)-AA(3.0)-) Tg 22° C. Average particle diameter: 0.1 μm, concentration: 43 mass %, equilibrium moisture content at 25° C. and 60% RH: 0.6 mass %, ionic conductivity: 4.2 mS/cm (the ionic conductivity measurement is carried out for a latex stock solution (43 mass %) at 25° C. using a conductivity meter CM-30S manufactured by TOA Electronics Ltd.), pH: 8.4 SBR latexes mutually different in Tg can be prepared in the same manner by appropriately changing the ratio of styrene and butadiene.

<<Preparation of Emulsion Layer (Light-Sensitive Layer) Coating Solution-1)

1000 g of the fatty acid silver dispersion obtained above, 276 ml of water, 33 g of Pigment-1 dispersion, 21 g of Organic polyhalogen compound-1 dispersion, 58 g of Organic polyhalogen compound-2 dispersion, 173 g of Phthalazine compound-1 solution, 1082 g of SBR latex (Tg: 22° C.), 299 g of Reducing agent-1 dispersion, 5.7 g of Development accelerator-1 dispersion, 9 ml of Mercapto compound-1 aqueous solution, and 27 ml of Mercapto compound-2 aqueous solution were successively added. Immediately before coating, to the resulting mixture, 117 g of Silver halide mixed emulsion A was added, and well mixed to prepare an emulsion layer coating solution. The resulting solution was fed as it was to a coating die for coating.

The viscosity of the emulsion layer coating solution was determined by means of a B-model viscometer from Tokyo Instrument Co., Ltd., and was found to be 25 [mPa.s] at 40° C. (No. 1 rotor, 60 rpm).

The viscosities of the coating solution at 25° C. determined by means of a RFS fluid spectrometer produced by Rheometrics Far East Co., Ltd., were 230, 60, 46, 24, and 18 [mPa.s] at shear rates of 0.1, 1, 10, 100, and 1000[1/sec], respectively.

The amount of zirconium in the coating solution was 0.38 mg per gram of silver.

<<Preparation of Emulsion Layer (Light-Sensitive Layer) Coating Solution-2)

1000 g of the fatty acid silver dispersion obtained above, 276 ml of water, 35 g of Pigment-1 dispersion, 32 g of Organic polyhalogen compound-1 dispersion, 46 g of Organic polyhalogen compound-2 dispersion, 173 g of Phthalazine compound-1 solution, 1082 g of SBR latex (Tg: 20° C.), 153 g of Reducing agent-2 dispersion, 55 g of Hydrogen bonding compound-1 dispersion, 4.8 g of Development accelerator-1 dispersion, 5.2 g of Development accelerator-2 dispersion, 2.1 g of Tone modifier-1 dispersion, and 8 ml of Mercapto compound-2 aqueous solution were successively added. Immediately before coating, to the resulting mixture, 140 g of Silver halide mixed emulsion A was added, and well mixed to prepare an emulsion layer coating solution. The resulting solution was fed as it was to a coating die for coating.

The viscosity of the emulsion layer coating solution was determined by means of a B-model viscometer from Tokyo Instrument Co., Ltd., and was found to be 40 [mPa.s] at 40° C. (No. 1 rotor, 60 rpm).

The viscosities of the coating solution at 25° C. determined by means of a RFS fluid spectrometer produced by Rheometrics Far East Co., Ltd., were 530, 144, 96, 51, and 28 [mPa.s] at shear rates of 0.1, 1, 10, 100, and 1000 [1/sec], respectively.

The amount of zirconium in the coating solution was 0.25 mg per gram of silver.

<<Preparation of Emulsion-Side Intermediate Layer Coating Solution>>

To 1000 g of polyvinyl alcohol PVA-205 (manufactured by Kuraray Co., Ltd.), 272 g of a 5 mass % dispersion of pigment, 4200 ml of a 19 mass % solution of methyl methacrylate/styrene/butyl acrylate/hydroxyethyl methacrylate/acrylic acid copolymer (copolymerization weight ratio 64/9/20/5/2) latex, 27 ml of a 5 mass % aqueous solution of Aerosol OT (manufactured by American Cyanamide Co.), and 135 ml of diammonium phthalate, water was added to make the total amount 10000 g. The mixture was adjusted to pH 7.5 with NaOH, resulting in an intermediate layer coating solution. The solution was fed to a coating die so as to achieve 9.1 ml/m².

The viscosity of the coating solution was determined by means of a B-model viscometer, and found to be 58 [mPa.s] at 40° C. (No. 1 rotor, 60 rpm).

<<Preparation of Emulsion-Side Protective-Layer First Layer Coating Solution>>

64 g of inert gelatin was dissolved in water. To the resulting solution, 112 g of a 19.0 mass % solution of methyl methacrylate/styrene/butyl acrylate/hydroxyethyl methacrylate/acrylic acid copolymer (copolymerization weight ratio 64/9/20/5/2) latex, 30 ml of a 15 mass % methanol solution of phthalic acid, 23 ml of a 10 mass % aqueous solution of 4-methylphthalic acid, 28 ml of sulfuric acid with a concentration of 0.5 ml/L, 5 ml of a 5 mass % aqueous solution of Aerosol OT (manufactured by American Cyanamide Co.), 0.5 g of phenoxy ethanol, and 0.1 g of benzisothiazolinone were added. To the mixture, water was added to make the total amount 750 g, resulting in a coating solution. 26 ml of 4 mass % chrome alum was mixed therein by a static mixer immediately before coating. The resulting mixture was fed to a coating die so as to achieve 18.6 ml/m².

The viscosity of the coating solution was determined by means of a B-model viscometer, and found to be 20 [mPa.s] at 40° C. (No. 1 rotor, 60 rpm).

<<Preparation of Emulsion-side Protective-Layer Second Layer Coating Solution>>

80 g of inert gelatin was dissolved in water. To the resulting solution, 102 g of a 27.5 mass % solution of methyl methacrylate/styrene/butyl acrylate/hydroxyethyl methacrylate/acrylic acid copolymer (copolymerization weight ratio 64/9/20/5/2) latex, 5.4 ml of a 2 mass % solution of fluorine-containing surfactant (F-1), 5.4 ml of a 2 mass % solution of fluorine-containing surfactant (F-2), 23 ml of a 5 mass % aqueous solution of Aerosol OT (manufactured by American Cyanamide Co.), 4 g of polymethyl methacrylate fine particles (average particle diameter 0.7 μm), 21 g of polymethyl methacrylate fine particles (average particle diameter 4.5 em), 1.6 g of 4-methylphthalic acid, 4.8 g of phthalic acid, 44 ml of sulfuric acid with a concentration of 0.5 mol/L, and 10 mg of benzisothiazolinone were added. To the mixture, water was added to make the total amount 650 g. 445 ml of an aqueous solution containing 4 mass % chrome alum and 0.67 mass % phthalic acid were mixed therein by a static mixer immediately before coating, resulting in a surface protective layer coating solution. The solution was fed to a coating die so as to achieve 8.3 ml/m².

The viscosity of the coating solution was determined by means of a B-model viscometer, and found to be 19 [mPa.s] at 40° C. (No. 1 rotor, 60 rpm).

<<Preparation of Photothermographic Material-1>>

On the back surface side of the undercoated support, an antihalation layer coating solution and a back-side protective layer coating solution were simultaneously coated in multilayer so that the gelatin coating amount became 0.44 g/m² and the gelatin coating amount became 1.7 g/m², respectively, and dried, to prepare a back layer.

On the surface opposite to the back surface, the emulsion layer, the intermediate layer, the protective-layer first layer, and the protective-layer second layer were simultaneously coated in multilayer by a slide bead coating process in this order, thereby to prepare a sample of the photothermographic material. At this step, the emulsion layer and the intermediate layer were temperature controlled to 31° C.; the protective-layer first layer, 36° C.; and the protective-layer second layer, 37 oc.

The coating amount (g/m²) of each compound of the emulsion layer is as follows.

| | |
|---|---|
| Silver behenate | 5.58 |
| Pigment (C.I. Pigment Blue 60) | 0.036 |
| Polyhalogen compound-1 | 0.12 |
| Polyhalogen compound-2 | 0.37 |
| Phthalazine compound-1 | 0.19 |
| SBR latex | 9.98 |
| Reducing agent complex-1 | 1.41 |
| Development accelerator-1 | 0.025 |
| Mercapto compound-1 | 0.002 |
| Mercapto compound-2 | 0.012 |
| Silver halide (in terms of Ag) | 0.091 |

The coating and drying conditions were as follows.

The coating was carried out at a speed of 160 m/min., and the clearance between the tip of the coating die and the support was set at 0.10 to 0.30 mm. The pressure in a reduced pressure chamber was set at a pressure lower than atmospheric pressure by 196 to 882 Pa. Electrostatic charges were eliminated from the support by ionic air before coating.

In a subsequent chilling zone, the coating solutions applied were cooled by air having a dry-bulb temperature of 10 to 20° C., followed by non-contact type transfer. Then, the sample was dried by dry air having a dry-bulb temperature of 23 to 45° C., and a wet-bulb temperature of 15 to 21° C. in a helical non-contact type drying apparatus.

After drying, the sample was subjected to moisture conditioning at 25° C. and humidity 40% to 60% RH, and then, heated so that the temperature of the film surface was elevated to 70 to 90° C. After heating, the film surface was cooled to 25° C.

The prepared photothermographic material showed matting degrees of 550 seconds for the light-sensitive layer side, and 130 seconds for the back surface side, in terms of Bekk smoothness. Whereas, the pH of the film surface on the light-sensitive layer surface side was determined, and found to be 6.00.

<<Preparation of Phtothermographic material-2>>

Photothermographic material-2 was prepared in the same manner as with Photothermographic material-1, except that Emulsion layer coating solution-1 was changed to Emulsion layer coating solution-2, further, that Yellow dye compound-1 was removed from the antihalation layer, and that the fluorine-containing surfactants of the back-side protective layer and the emulsion-side protective layer were changed from F-1 and F-2 to F-3 and F-4, respectively, in Photothermographic material-1.

The coating amount (g/m²) of each compound of the emulsion layer at this step is as follows.

| | |
|---|---|
| Silver behenate | 5.27 |
| Pigment (C.I. Pigment Blue 60) | 0.036 |
| Polyhalogen compound-1 | 0.17 |
| Polyhalogen compound-2 | 0.28 |
| Phthalazine compound-1 | 0.18 |
| SBR latex | 9.43 |
| Reducing agent-2 | 0.77 |
| Hydrogen bonding compound-1 | 0.28 |
| Development accelerator-1 | 0.019 |
| Development accelerator-2 | 0.020 |
| Tone modifier-1 | 0.008 |
| Mercapto compound-2 | 0.003 |
| Silver halide (in terms of Ag) | 0.091 |

Below, the chemical structures of the compounds used in examples of this embodiment will be shown.

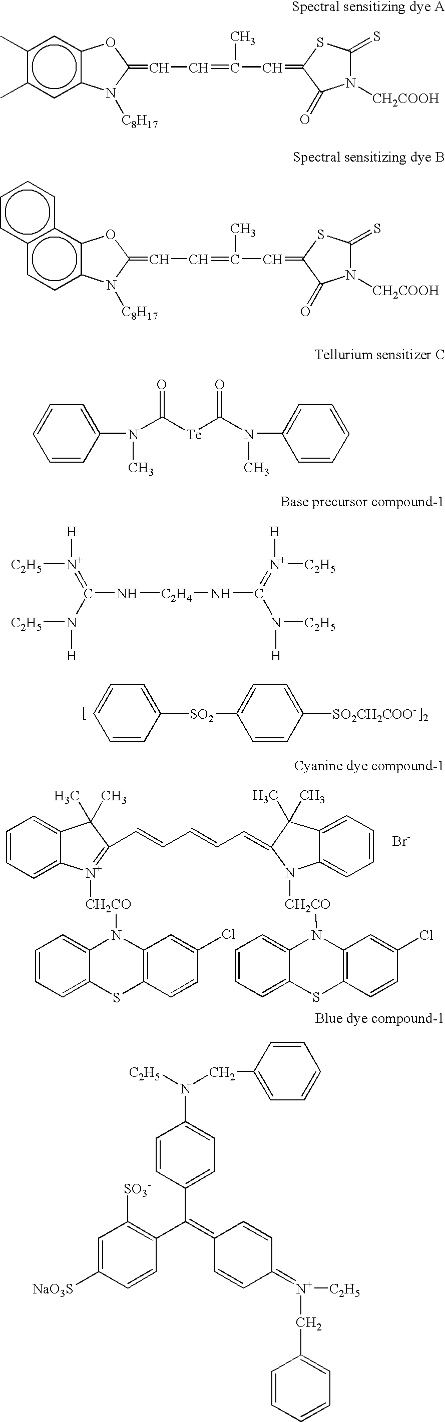

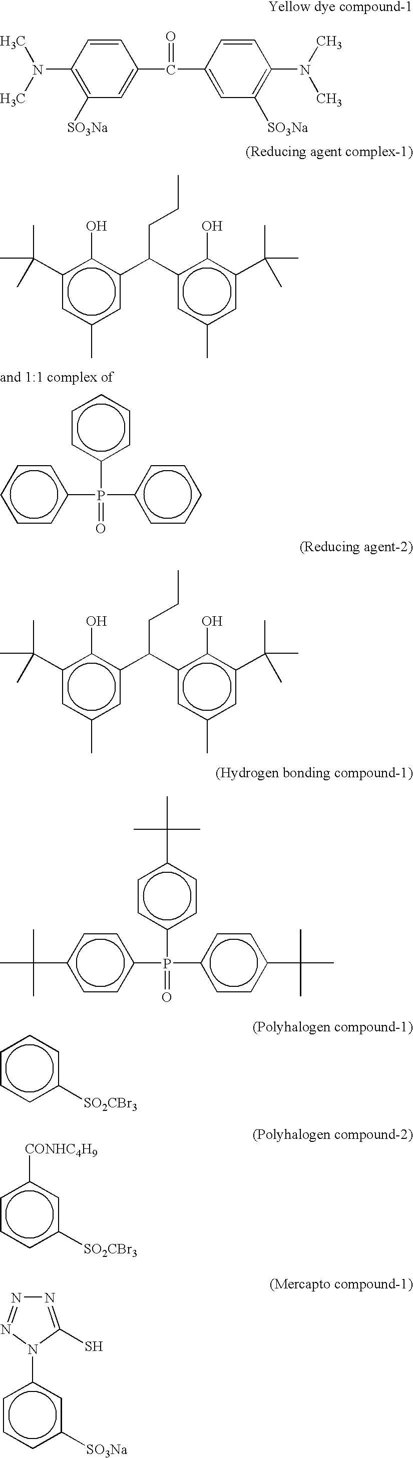

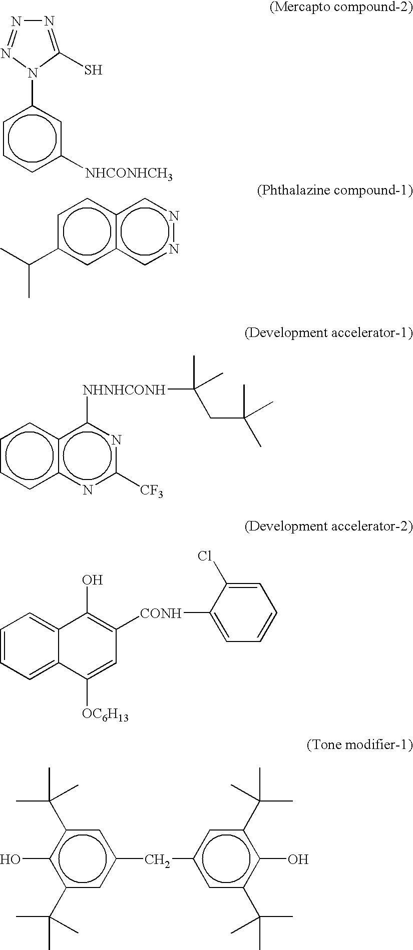

CF₃(CF₂)nCH₂CH₂SCH₂CH₂COOLi (F-1)

Mixture for n=5 to 11

CF₃(CF₂)nCH₂CH₂O(CH₂CH₂O)mH (F-2)

Mixture for n=5 to 11, and m=5 to 15

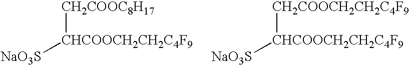

(Evaluation of Photographic Performances)

Each sample obtained was cut into a half size, and each cut sample was packaged in the following packaging material under the environment of 25° C. and 50% RH, and stored at ordinary temperatures for 2 weeks. Then, the following evaluations were carried out.

(Packaging Material)

PET 10 μ/PE 12 μ/aluminum foil 9 μ/Ny 15 μL/3% carbon-containing polyethylene 50 μ

Oxygen permeability: 0.02 ml/atm.m².25° C.day, moisture permeability: 0.10 g/atm.m².25° C.day.

Each sample was subjected to exposure and heat development (by 4 panel heaters respectively set at 112° C.-119° C.-121° C.-121° C. for a total of 24 seconds for Photothermographic material-1, and for a total of 14 seconds for Photothermographic material-2) by means of FUJI Medical Dry Laser Imager FM-DPL (equipped with a 660-nm semiconductor laser with a maximum output of 60 mW (IIIB)). Each resulting image was evaluated by means of an internal densitometer.

As described above, according to the invention, in a heat development method for performing heat development by applying light or heat onto a heat-developable recording material including a photothermographic material or a light-sensitive heat-sensitive recording material, the target temperature of the heater is to be increased than normal immediately after the start-up of the heat development apparatus. Subsequently, the increase range is to be reduced with time. As a result, the density becomes more stable, and it is possible to shorten the print time.

Similarly, in a heat development method for performing heat development by applying light or heat onto a heat-developable recording material including a photothermographic material or a light-sensitive heat-sensitive recording material, the recording light quantity or the recording heat quantity is to be increased than normal immediately after the start-up of the heat development apparatus. Subsequently, the increase range is to be reduced with time. As a result, the density becomes more stable, and it is possible to shorten the print time.

Then, further, the target temperature of the heater is to be increased than normal and the recording light quantity or the recording heat quantity is also to be increased than normal immediately after the start-up of the heat development apparatus. Subsequently, the increase range is to be reduced with time. This produces effects of making it possible to more shorten the print time and to perform more delicate control.

What is claimed is:

1. A heat development method for performing heat development by applying light or heat onto a heat-developable recording material including a photothermographic material or a light-sensitive heat-sensitive recording material, characterized in that the target temperature of a heater is increased than normal immediately after the start-up of a heat development apparatus, and subsequently, the increase range is reduced with time.

2. A heat development method for performing heat development by applying light or heat onto a heat-developable recording material including a photothermographic material or a light-sensitive heat-sensitive recording material, characterized in that the recording light quantity or the recording heat quantity is increased than normal immediately after the start-up of a heat development apparatus, and subsequently, the increase range is reduced with time.

3. A heat development method for performing heat development by applying light or heat onto a heat-developable recording material including a photothermographic material or a light-sensitive heat-sensitive recording material, characterized in that the target temperature of a heater is increased than normal, and the recording light quantity or the recording heat quantity is increased than normal immediately after the start-up of a heat development apparatus, and subsequently, the increase range is reduced with time.
